(19) United States
(12) Patent Application Publication
(10) Pub. No.: US 2026/0115791 A1
(43) Pub. Date: Apr. 30, 2026

(54) ALPHA-FE-CONTAINING RARE EARTH-IRON-BASED MAGNETIC POWDER, PRODUCTION METHOD THEREOF, MAGNETIC MATERIAL FOR MAGNETIC FIELD AMPLIFICATION, AND MAGNETIC MATERIAL FOR HYPER-HIGH FREQUENCY ABSORPTION

(71) Applicant: NICHIA CORPORATION, Anan-shi (JP)

(72) Inventors: Jun AKAMATSU, Tokushima-shi (JP); Satoshi ABE, Anan-shi (JP); Ryoya OKAZAKI, Anan-shi (JP); Nobuyoshi IMAOKA, Anan-shi (JP); Haruhiko ABE, Anan-shi (JP); Takahiro NOZUE, Anan-shi (JP)

(73) Assignee: NICHIA CORPORATION, Anan-shi (JP)

(21) Appl. No.: 19/272,306

(22) Filed: Jul. 17, 2025

(30) Foreign Application Priority Data
Jul. 18, 2024 (JP) 2024-114952
Dec. 27, 2024 (JP) 2024-232652
Jul. 11, 2025 (JP) 2025-117135

(51) Int. Cl. B22F 1/16; B22F 1/142; B22F 1/145; H01F 1/057; H01F 41/02

(52) U.S. Cl. CPC B22F 1/16; B22F 1/142; B22F 1/145; H01F 1/0571; H01F 41/0293; B22F 2201/03; B22F 2301/355; B22F 2304/05; B22F 2304/10

(57) ABSTRACT

The present disclosure relates to an α-Fe-containing rare earth-iron-based magnetic powder including: a core region containing a rare earth R and Fe, where R represents at least one selected from the group consisting of Y, La, Ce, Pr, Nd, Pm, Eu, Gd, Tb, Dy, Ho, Er, Tm, Yb, Lu, and Sm; an α-Fe-containing region located outside the core region and containing α-Fe and at least one selected from the group consisting of oxides, nitrides, and oxynitrides of the rare earth R; and an iron oxide-containing region located outside the α-Fe-containing region and containing magnetite or maghemite.

### CROSS-REFERENCE TO RELATED PATENT APPLICATION

This application claims priority to Japanese Patent Application No. 2024-114952 filed on Jul. 18, 2024, Japanese Patent Application No. 2024-232652 filed on Dec. 27, 2024, and Japanese Patent Application No. 2025-117135 filed on Jul. 11, 2025. The disclosures of Japanese Patent Application No. 2024-114952, Japanese Patent Application No. 2024-232652, and Japanese Patent Application No. 2025-117135 are hereby incorporated by reference in their entirety.

### TECHNICAL FIELD

The present disclosure relates to an α-Fe-containing rare earth-iron-based magnetic powder, a production method thereof, a magnetic material for magnetic field amplification, and a magnetic material for hyper-high frequency absorption.

### BACKGROUND ART

In recent years, as devices have become more compact and multifunctional and computing speeds have increased, the driving frequency has been increasing, and the use of high or hyper-high frequency-based devices has steadily grown. In particular, the progress of power devices used in the high frequency range of at least 1 MHz but lower than 1 GHz has been attracting attention. For example, the market for GaN electronic devices as devices for high-frequency, high-output wireless applications or for power electronics is expected to significantly grow in the future. Higher-frequency GaN circuits for power electronics require not only higher-frequency GaN devices but also higher-frequency passive components. For example, GaN contactless power transfer uses a frequency of higher than 10 MHz and needs coils including magnetic core materials that can follow high frequencies. Further, the demand for inductors, reactors, transformers, and antennas that can operate in the high frequency range of at least 20 MHz but lower than 1 GHz is increasing day by day. At present, however, due to the lack of magnetic core materials with good high-frequency characteristics, air-core coils have to be used, which disadvantageously increases the overall circuit size, even if devices can be downsized by using GaN for higher frequency applications. An example of a high frequency magnetic material known to date is a rare earth-iron-nitrogen-based magnetic material in which a powder surface is coated with a ferrite-based magnetic material (WO 2008/136391).

Also noteworthy is the progress of information infrastructures in the hyper-high frequency range of 1 GHz to 1 THz. There are various needs for high-frequency characteristics of materials which can absorb signals in the frequency range of at least 1 GHz but lower than 10 GHz for 5G, of at least 10 GHz but lower than 100 GHz for 5G+, or of 100 GHz to 1 THz for 6G, and their harmonics and other spurious signals. These needs have recently been increasing. Particularly, no material currently exists that can absorb a wide range of hyper-high frequencies of 1 GHz or more or even 10 GHz or more, and there are great expectations for the development of very broad frequency band hyper-high frequency absorbing materials which can be widely used in the frequency range of 1 GHz to 1 THz. Examples of high frequency magnetic materials known to date include a rare earth-iron-nitrogen-based magnetic material including a powder having a surface coated with a ferrite-based magnetic material.

### SUMMARY OF DISCLOSURE

### Technical Problem

An object of the present disclosure is to provide a magnetic powder that is highly responsive to magnetic fields, and a method of producing the magnetic powder.

### Solution to Problem

An α-Fe-containing rare earth-iron-based magnetic powder according to an aspect of the present disclosure includes: a core region containing a rare earth R and Fe, where R represents at least one selected from the group consisting of Y, La, Ce, Pr, Nd, Pm, Eu, Gd, Tb, Dy, Ho, Er, Tm, Yb, Lu, and Sm; an α-Fe-containing region located outside the core region and containing α-Fe and at least one selected from the group consisting of oxides, nitrides, and oxynitrides of the rare earth R; and an iron oxide-containing region located outside the α-Fe-containing region and containing magnetite or maghemite.

Further, a method of producing an α-Fe-containing rare earth-iron-based magnetic powder according to an aspect of the present disclosure includes: performing a phosphorus treatment including adding an inorganic acid to a slurry containing: a rare earth-iron-based magnetic powder containing a rare earth R and Fe, where R represents at least one selected from the group consisting of Y, La, Ce, Pr, Nd, Pm, Eu, Gd, Tb, Dy, Ho, Er, Tm, Yb, Lu, and Sm; water; and a phosphorus-containing substance, to form a phosphorus compound coating portion on the rare earth-iron-based magnetic powder, thereby obtaining a rare earth-iron-based magnetic powder having the phosphorus compound coating portion; performing an oxidation including heat-treating the rare earth-iron-based magnetic powder having the phosphorus compound coating portion at a temperature that is at least 350° C. but not higher than 600° C. in an oxygen-containing atmosphere to obtain an oxidized rare earth-iron-based magnetic powder having the phosphorus compound coating portion; and performing an annealing including heat-treating the oxidized rare earth-iron-based magnetic powder having the phosphorus compound coating portion at a temperature that is at least 200° C. but not higher than 600° C. in an atmosphere containing an inert gas or a nitrogen atom-free reducing gas. The method may further include, after the annealing, heat-treating the α-Fe-containing rare earth-iron-based magnetic powder at a temperature that is at least 200° C. but not higher than 600° C. in an oxygen-containing atmosphere.

The present disclosure can provide a magnetic powder highly responsive to magnetic fields, and a method of producing the magnetic powder.

### BRIEF DESCRIPTION OF DRAWINGS

FIG. 1 shows the frequency dependencies of the complex relative permeability of the magnetic powders produced in Examples 1 to 3 and Comparative Examples 1 to 4.

FIG. 2 shows XRD patterns of the magnetic powders produced in Examples 1 and 3 and Comparative Examples 1 and 2.

FIG. 3 shows an STEM-DF image of a cross-section near the surface of the magnetic powder produced in Comparative Example 2. The EDS point analysis locations indicated in Table 3 are shown in this figure.

FIG. 4 shows an STEM-DF image of a cross-section near the surface of the magnetic powder produced in Example 1. The EDS point analysis locations indicated in Table 4 are shown in this figure.

FIG. 5 shows an STEM-DF image of a cross-section near the surface of the magnetic powder produced in Example 3. The EDS point analysis locations indicated in Table 5 are shown in this figure.

FIG. 6 shows an STEM-EDS mapping image of Fe in a cross-section of the magnetic powder produced in Comparative Example 2.

FIG. 7 shows an STEM-EDS mapping image of Fe in a cross-section of the magnetic powder produced in Example 1.

### DESCRIPTION OF EMBODIMENTS

Embodiments of the present disclosure are described in detail below. The following embodiments, however, are intended as examples to give a concrete form to the technical idea of the present disclosure and are not intended to limit the scope of the present disclosure to the following embodiments. Herein, the term “step” encompasses not only an independent step but also a step that may not be clearly distinguished from other steps, as long as a desired object of the step is achieved. Moreover, numerical ranges indicated using “to” refer to ranges including the numerical values before and after “to” as the minimum and maximum, respectively.

Herein, the term “high frequency” refers to electromagnetic waves with high frequencies. In this disclosure, the term particularly refers to electromagnetic waves of at least 1 MHz but lower than 1 GHz, unless otherwise stated. Herein, the term “hyper-high frequency” refers to electromagnetic waves with higher frequencies than “high frequency”. In this disclosure, the term particularly refers to electromagnetic waves of at least 1 GHz but lower than 1 THz, unless otherwise stated.

Herein, the term “good efficiency” means that the ratio of the imaginary part (μ″) to the real part (μ′) of the complex relative permeability (μ), i.e., tan δ=μ″/μ′ (also called loss factor), of the magnetic material is small at a given frequency f. Herein, δ is called the phase difference, and the value of (90°−δ) is called the phase angle θ. Thus, the term “good efficiency” means a large phase angle θ close to 90°, contrary to δ. With a small tan δ or δ value or a large phase angle θ close to 90°, it is possible to amplify electromagnetic waves at a given frequency f while reducing their loss. With regard to magnetic field amplification characteristics, a larger phase angle θ (smaller tan δ or δ value) is referred to as “improved phase angle θ (tan δ)”, while a smaller phase angle θ (larger tan δ or δ value) is referred to as “deteriorated phase angle θ (tan δ)”.

Herein, the phrase “highly responsive to magnetic fields” means that (1) at a given frequency f in a high frequency range, the magnetic moment of the magnetic material follows the magnetic field so that the magnetic material has a large real part (μ′) and a small imaginary part (μ″) of the complex relative permeability (μᵣ) and therefore has a low tan δ; or (2) at a given frequency f in a hyper-high frequency range, the magnetic material responds to the magnetic field, e.g., by resonating with electromagnetic waves, so that it has a large imaginary part (μ″). Materials with low magnetization delay and losses in a high frequency range have a high μ′ and a low μ″, are highly responsive to magnetic fields, and can serve as materials for magnetic field amplification. Materials that can follow magnetic fields, but with magnetization delay and losses, in a hyper-high frequency range have a high μ″, are highly responsive to magnetic fields, and can serve as electromagnetic wave absorbing materials. Materials that do not respond to magnetic fields have a complex relative permeability equal to the complex relative permeability of vacuum (μ′=1, μ″=0, μᵣ=1) and cannot serve as magnetic materials for high frequency applications.

Herein, “magnetic field amplification” characteristics mean that the real part (μ′) of the complex relative permeability of the magnetic material is larger than the real part (=1) of the relative permeability of vacuum, and the magnetic field in the space where the magnetic material is placed is increased as compared to the magnetic field in vacuum (or in the air). Good or high magnetic field amplification characteristics mean high μ′. Materials with a μ′ value exceeding 2 at a given frequency f are referred to as “magnetic materials for magnetic field amplification” (at the frequency f). The term “relative permeability” when used alone is a general term for the absolute values of the real part and the imaginary part of the complex relative permeability. High relative permeability or high permeability means that the real part of the relative permeability is high, unless otherwise stated.

### α-Fe-Containing Rare Earth-Iron-Based Magnetic Powder

An α-Fe-containing rare earth-iron-based magnetic powder according to the present embodiment includes a core region containing a rare earth R and Fe, where R represents at least one selected from the group consisting of Y, La, Ce, Pr, Nd, Pm, Eu, Gd, Tb, Dy, Ho, Er, Tm, Yb, Lu, and Sm; an α-Fe-containing region located outside the core region and containing α-Fe and at least one selected from the group consisting of oxides, nitrides, and oxynitrides of the rare earth R; and an iron oxide-containing region located outside the α-Fe-containing region and containing magnetite or maghemite.

### Core Region

The core region contains a rare earth R and Fe, where R represents at least one selected from the group consisting of Y, La, Ce, Pr, Nd, Pm, Eu, Gd, Tb, Dy, Ho, Er, Tm, Yb, Lu, and Sm. R represents at least one selected from the group consisting of Y, La, Ce, Pr, Nd, Pm, Eu, Gd, Tb, Dy, Ho, Er, Tm, Yb, Lu, and Sm, among which Nd, Sm, and Ce are preferred to achieve high permeability.

Sm may constitute more than 50 at %, at least 70 at %, or at least 90 at % of the total rare earth R content. When the core region is formed of a rare earth-iron-nitrogen-based magnetic material that contains nitrogen and Sm and is crystalline with a tetragonal crystal structure, the magnetic powder is suitable as a magnetic material for magnetic field amplification advantageously having a high μ′ and a low phase angle θ in a frequency range of at least 10 MHz. When the material has a small crystallite size, the magnetic powder is suitably usable as both a magnetic material for hyper-high frequency absorption and a magnetic material for magnetic field amplification. Moreover, the rare earth-iron-nitrogen-based magnetic material containing Sm and having a tetragonal crystal structure or a small crystallite size is also highly practical in that the cost is low. Note that when the rare earth-iron-nitrogen-based magnetic material containing Sm is used in applications characterized by high relative permeability, Sm preferably constitutes less than 50 at %. In this case, Sm may constitute less than 50 at %, not more than 25 at %, or not more than 5 at % of the total rare earth R content. Moreover, the core region preferably further contains nitrogen (N) to provide a good efficiency in a high frequency range.

An example of the composition of the core region is a rare earth-iron-nitrogen-based magnetic material containing a rare earth R, a ferromagnetic component (X), and nitrogen (N) as represented by the following formula 1:

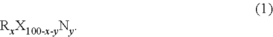

In the formula, x and y represent the atomic percentages (at %) of R and N, respectively. Preferably, x is at least 3 but not higher than 30, more preferably at least 3 but not higher than 15. Preferably, y is at least 2 but not higher than 30, more preferably at least 2 but not higher than 25. X is at least one selected from the group consisting of Fe, Co, and Ni. The total amount of Co and Ni is preferably not more than 50 at % and may be not more than 1 at % based on the total amount of Fe, Co, and Ni. When Co is present in an amount of at least 1 at %, the curie point tends to increase, resulting in higher thermal properties. When Ni is present in an amount of at least 1 at %, the oxidation resistance tends to increase. Herein, Fe, Co, and Ni may be collectively referred to as X components.

An example of the composition of the core region is a rare earth-iron-nitrogen-based magnetic material containing a rare earth R, a ferromagnetic component (X), an M component, and nitrogen (N) as represented by the following formula 2:

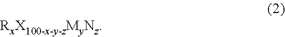

In the formula, x, y and z represents the atomic percentages (at %) of R, M, and N, respectively. Preferably, x is at least 2 but not higher than 24, more preferably at least 2 but not higher than 15. Preferably, y is at least 0.0001 but not higher than 25, more preferably at least 0.5 but not higher than 25. Preferably, z is at least 2 but not higher than 50, more preferably at least 3 but not higher than 50. X is the same as that in formula 1, and M is at least one selected from the group consisting of Ti, V, Mo, Nb, W, Si, Al, Mn, and Cr. When the rare earth-iron-nitrogen-based magnetic material with a tetragonal crystal structure contains such an M component, it has planar magnetic anisotropy.

When the nitrogen atom content is within the range indicated for formula 1 or 2, the material advantageously has a high real part of the relative permeability and a low tan δ. Examples of the crystal structure of the core region formed of the rare earth-iron-nitrogen-based magnetic material with a composition represented by formula 1 or 2 include Th₂Zn₁₇ type, Th₂Ni₁₇ type, and ThMn₁₂ type crystal structures. The magnetic material with any of these crystal structures is preferably a planar anisotropic material because it has a high μ′ and can serve as a broadband absorbing material in a hyper-high frequency range. When organized in this perspective, examples of preferred rare earth components in the crystal structures include Ce, Pr, Nd, Eu, Gd, and Tb for the rhombohedral Th₂Zn₁₇ type crystal structure; Y, Dy, Ho, Er, Tm, and Lu for the hexagonal Th₂Ni₁₇ type crystal structure; and Sm, Er, Tm, Y, Ce, Eu, Gd, and Lu for the tetragonal ThMn₁₂ type crystal structure. Moreover, the rare earth-iron-nitrogen-based magnetic material containing a nitrogen component, even if it is amorphous, can materialize a magnetic material for high frequency applications that has high permeability and high efficiency in a high frequency range. The rare earth component in such a magnetic material is preferably a light/medium rare earth element such as La, Ce, Pr, Nd, or Sm.

An example of the composition of the core region is a rare earth-iron-based magnetic material containing a rare earth R and a ferromagnetic component (X) as represented by the following formula 3:

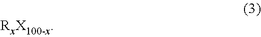

In the formula, x represents the atomic percentage (at %) of R. Preferably, x is at least 2 but not higher than 33, more preferably at least 5 but not higher than 15. X is as defined above. In the case of a “rare earth-iron” magnetic material that is a rare earth-iron-based magnetic material free of nitrogen, boron (B), and carbon (C), examples of the crystal structure of the core region include Th₂Zn₁₇ type, Th₂Ni₁₇ type, and ThMn₁₂ type crystal structures. The magnetic material with any of these crystal structures is preferably a planar anisotropic material because it has a high μ′. Specifically, examples of preferred rare earth components in the crystal structures include Ce, Pr, Nd, Eu, Gd, Tb, and Sm for the rhombohedral Th₂Zn₁₇ type crystal structure; Y, Dy, Ho, Er, Tm, and Lu for the hexagonal Th₂Ni₁₇ type crystal structure; and Tb, Y, Ce, Eu, Gd, and Lu for the tetragonal ThMn₁₂ type crystal structure.

An example of the composition of the core region is a rare earth-iron-based magnetic material containing a rare earth R, a ferromagnetic component (X), and boron (B) as represented by the following formula 4:

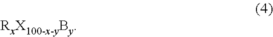

In the formula, x and y represent the atomic percentages (at %) of R and B, respectively. Preferably, x is at least 2 but not higher than 30, more preferably at least 3 but not higher than 15. Preferably, y is at least 2 but not higher than 30, more preferably at least 3 but not higher than 15. X is as defined above, but X within a range of at least 0.0001 at % but lower than 50 at % may be replaced by an M component as defined above. When the rare earth-iron-based magnetic material with a tetragonal crystal structure contains such an M component, it has high permeability.

The rare earth-iron-based magnetic material mainly containing boron is also preferably a planar anisotropic material because it has a high μ′. Examples of preferred rare earth components in the tetragonal Nd₂Fe₁₄B type crystal structure include Sm, Er, and Tm.

An example of the composition of the core region is a rare earth-iron-based magnetic material containing a rare earth R, a ferromagnetic component (X), and carbon (C) as represented by the following formula 5:

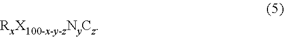

This rare earth-iron-based magnetic material may be a rare earth-iron-nitrogen-based magnetic material further containing nitrogen (N). In the formula, x, y, and z represent the atomic percentages (at %) of R, N, and C, respectively. Preferably, x is at least 3 but not higher than 30, more preferably at least 3 but not higher than 15. Preferably, y+z is at least 2 but not higher than 30, more preferably at least 2 but not higher than 25. Preferably, y/z is at least 0 but not higher than 10000, more preferably at least 0 but not higher than 1000. X is as defined above, but X within a range of at least 0.0001 at % but lower than 50 at % may be replaced by an M component. When the rare earth-iron-based magnetic material or rare earth-iron-nitrogen-based magnetic material represented by formula 5 with a tetragonal crystal structure contains such an M component, it has planar magnetic anisotropy. When the nitrogen atom content and the carbon atom content are within the respective ranges indicated for formula 5, the material advantageously has a high real part of the relative permeability and a low tan δ. Examples of preferred rare earth components in the crystal structures are the same as those described for the rare earth-iron-nitrogen-based magnetic material. As more nitrogen is replaced by carbon, the permeability, curie point, etc. deteriorate, but the heat resistance improves slightly.

Note that although all the magnetic materials of formulas 1 to 5 can constitute the core region according to the present disclosure, the components of the rare earth-iron-based magnetic materials particularly preferably include nitrogen. When the rare earth-iron-nitrogen-based magnetic materials are selected as the core region according to the present disclosure, high permeability as well as high responsiveness to magnetic fields can be provided.

The average particle size of the core region is not limited as long as it is within a particle size range that can achieve good efficiency in a target frequency range. For example, the average particles size is preferably at least 0.05 μm but not more than 1000 μm, more preferably at least 0.1 μm but not more than 500 μm, still more preferably at least 0.5 μm but not more than 161 μm, particularly preferably at least 0.5 μm but not more than 50 μm. Here, the average particle size refers to the median diameter measured under dry conditions using a laser diffraction particle size distribution analyzer. Specifically, the average particle size is defined as D50, which represents the particle size corresponding to 50% of the cumulative particle size distribution by volume.

Preferably, the core region contains a rare earth-iron-nitrogen-based compound, and the resulting magnetic powder has an XRD diffraction pattern in which the ratio (I)/(II) of the diffraction peak intensity (I) of the (110) plane of α-Fe to the peak intensity (II) of the strongest line of the rare earth-iron-nitrogen-based compound is at least 0.01 but lower than 100, more preferably at least 0.1 but not higher than 10. A ratio within the above range has the effect of improving the μ′ while maintaining a low tan δ around 100 MHz.

Preferably, the core region contains a rare earth-iron-nitrogen-based compound, and the resulting magnetic powder has an XRD diffraction pattern in which the ratio (I)/(II) of the diffraction peak intensity (I) of the (511) plane of magnetite or maghemite to the peak intensity (II) of the strongest line of the rare earth-iron-nitrogen-based compound is at least 0.01 but lower than 100, more preferably at least 0.1 but lower than 100. A ratio within the above range has the effect of improving the μ′ while maintaining a low tan δ.

Preferably, the core region contains a rare earth-iron-nitrogen-based compound, and the resulting magnetic powder has an XRD diffraction pattern in which the ratio (I)/(II) of the diffraction peak intensity (I) of the (104) plane of hematite to the diffraction peak intensity (II) of the (511) plane of magnetite or maghemite is at least 0 but lower than 10, more preferably at least 0 but lower than 5. At a ratio within the above range, the loss due to the electric insulation effect of hematite can be improved, and also the magnetic coupling effect of maghemite and/or magnetite can be obtained, thereby providing an effect of markedly improving the permeability.

### Method of Producing Core Region

The rare earth-iron-based magnetic powder constituting the core region can be produced by any method. Exemplary production methods using a solid phase method or a precipitation method are described in detail below.

### Solid Phase Method

A method of producing a rare earth-iron-based magnetic powder according to a solid phase method includes:
mixing an R oxide powder, an Fe raw material, and a Ca powder (mixing step); and
reducing the resulting mixture (reduction step).

Preferably, the method of producing a rare earth-iron-based magnetic powder according to a solid phase method further includes nitriding the alloy particles obtained in the reduction step (nitridation step).

### Mixing Step

In the mixing step, a rare earth R oxide powder, an Fe raw material, and a Ca powder may be mixed to obtain alloy particles. In the mixing step, not only metallic Fe but also Fe₂O₃ and/or Fe₃O₄ can be used as the Fe raw material. The amount of Fe₂O₃ and/or Fe₃O₄ (the total number of moles of Fe in Fe₂O₃ and/or Fe₃O₄ relative to the total number of moles of Fe in metallic Fe and Fe₂O₃ and/or Fe₃O₄), if used, is preferably not more than 30 at %. The reaction heat generated when the iron oxides are reduced by Ca may allow the overall reaction to uniformly proceed, thereby saving the external energy and enhancing the yield. The amount of granular Ca mixed needs to be enough to reduce the R oxide and the selectively mixed metal oxides. The amount of granular Ca mixed may be at least 0.5 times but not more than three times, preferably at least one time but not more than two times the equivalent amount of oxygen atoms in the R oxide and selectively mixed Fe₂O₃ and/or Fe₃O₄.

### Reduction Step

The powder mixture obtained in the mixing step may be placed in a heating vessel which can be vacuum-evacuated. After vacuum evacuation of the heating vessel, the powder mixture may be heated at a temperature of at least 600° C. but not higher than 1300° C., preferably at least 700° C. but not higher than 1200° C., more preferably at least 800° C. but not higher than 1100° C., while passing argon gas therethrough. If the heating temperature is lower than 600° C., the reduction reaction of the oxides may not proceed. If the heating temperature is higher than 1300° C., the rare earth and Fe may melt into bulk form. Moreover, when the heating temperature is at least 700° C., the reduction time tends to be shortened, resulting in improved productivity. When the heating temperature is not higher than 1200° C., scattering of Ca tends to be reduced, resulting in further reduced variations during the reduction. To more uniformly perform the reduction reaction, the heat treatment time may be not longer than four hours, preferably shorter than 120 minutes, more preferably shorter than 90 minutes. The lower limit of the heat treatment time is preferably at least 10 minutes, more preferably at least 30 minutes. Here, when the powder mixture contains an appropriate amount of Fe₂O₃ and/or Fe₃O₄ in addition to metallic Fe, it may undergo self-heating during the temperature rise, so that a uniform reaction can proceed efficiently. However, if metallic Fe is mixed with Fe₂O₃ and/or Fe₃O₄ in an amount, calculated as elementary Fe as described in the mixing step, which exceeds 30 at %, explosion or scattering may occur due to extremely high heat generation. Moreover, the particle size of the resulting rare earth-iron-based magnetic powder may be controlled by controlling the reduction temperature. Generally, the higher the reduction temperature, the larger the powder particle size.

### Nitridation Step

To obtain a nitrogen (N)-containing core region, the method may include nitriding the alloy particles obtained in the reduction step (nitridation step). In the nitridation step, the alloy particles may be cooled in argon gas to a temperature range of preferably at least 250° C. but not higher than 800° C., more preferably at least 300° C. but not higher than 600° C., more preferably at least 400° C. but not higher than 550° C. Subsequently, the heating vessel may be again vacuum-evacuated and then nitrogen gas may be introduced thereinto. The gas to be introduced is not limited to nitrogen and may be nitrogen atom-containing gas such as ammonia. The contents may be heated for several hours, preferably for about five hours, while passing nitrogen gas therethrough at atmospheric pressure or higher, followed by stopping the heating and leaving them to cool.

The product obtained after the reduction step or nitridation step may contain, in addition to the rare earth-iron-based magnetic powder, materials such as by-product CaO and unreacted metal calcium, which may be combined into sintered bulk form. In this case, a water washing step may be performed in which the product may be introduced into ion exchange water to separate the calcium oxide (CaO) and other calcium-containing components as a calcium hydroxide (Ca(OH)₂) suspension from the magnetic powder. In the water washing step, stirring in water, standing still, and supernatant removal may be repeated several times. Further, the residual calcium hydroxide may be sufficiently removed by washing the magnetic powder with acetic acid or the like. The water washing step is preferably performed after the heat treatment in the nitridation step because the residual unreacted Ca can be converted into calcium nitride (Ca₃N₂), which is easier to remove. The rare earth-iron-based magnetic powder obtained as above tends to have a sharper particle size distribution.

### Precipitation Method

A method of producing a rare earth-iron-based magnetic powder according to a precipitation method includes:
mixing a solution containing R and Fe with a precipitant to obtain a precipitate containing R and Fe (precipitation step);
firing the precipitate to obtain an oxide containing R and Fe (oxidation step);
heat-treating the oxide in a reducing gas-containing atmosphere to obtain a partial oxide (pretreatment step); and
reducing the partial oxide (reduction step).

Preferably, the method of producing a rare earth-iron-based magnetic powder according to a precipitation method further includes nitriding the alloy particles obtained in the reduction step (nitridation step).

### Precipitation Step

In the precipitation step, an R raw material containing a rare earth R and an Fe raw material containing iron Fe may be dissolved in a strong acid solution to prepare a solution containing R and Fe. Any R or Fe raw material which can be dissolved in a strong acid solution may be used. In view of availability, examples of the R raw material include R oxides, and examples of the Fe raw material include iron sulfate (FeSO₄). The concentration of the solution containing R and Fe may be appropriately adjusted within a range in which the R raw material and the Fe raw material can be substantially dissolved in the acid solution. In view of solubility, examples of the acid solution include sulfuric acid.

The solution containing R and Fe may be reacted with a precipitant to obtain an insoluble precipitate containing R and Fe. Here, the solution containing R and Fe can be any solution that contains R and Fe at the time of the reaction with a precipitant. For example, a solution containing an R raw material and a solution containing an Fe raw material may be separately prepared and individually added dropwise to be reacted with a precipitant. In preparing the separate solutions, the solutions may also be appropriately adjusted within a range in which the raw materials can be substantially dissolved in the acid solution. The precipitant may be any alkaline solution that can react with the solution containing R and Fe to give a precipitate. Examples include ammonia water and caustic soda, with caustic soda being preferred.

After separating the precipitate, the separated precipitate is preferably subjected to solvent removal in order to inhibit aggregation of the precipitate caused by evaporation of the residual solvent in which the precipitate has been re-dissolved during the heat treatment in the subsequent oxidation step, and to inhibit changes in properties such as particle size distribution and powder particle size. Specifically, when the solvent used is water, for example, the solvent removal may be performed by drying in an oven at a temperature of at least 70° C. but not higher than 200° C. for at least five hours but not longer than 12 hours.

The precipitation step may be followed by washing and separating the resulting precipitate. The washing process may be appropriately performed until the conductivity of the supernatant solution reaches 50 μS/cm or lower. The precipitate separation process may be performed, for example, by mixing the resulting precipitate with a solvent (preferably water), followed by filtration, decantation, or other separation methods.

### Oxidation Step

In the oxidation step, the precipitate formed in the precipitation step may be fired to obtain an oxide containing R and Fe. For example, the precipitate may be converted into an oxide by heat treatment. The heat treatment of the precipitate needs to be performed in the presence of oxygen, for example in an air atmosphere. Moreover, since the presence of oxygen is necessary, the non-metal portions of the precipitate preferably contain oxygen atoms. The heat treatment temperature in the oxidation step (hereinafter, oxidation temperature) is not limited, but it is preferably at least 700° C. but not higher than 1300° C., more preferably at least 900° C. but not higher than 1200° C. If the oxidation temperature is lower than 700° C., the oxidation tends to be insufficient. If the oxidation temperature is higher than 1300° C., the resulting rare earth-iron-based magnetic powder tends not to provide the desired shape, average particle size, or particle size distribution. The heat treatment time is not limited either and may be at least 0.5 hours but not longer than four hours, preferably at least one hour but not longer than three hours.

### Pretreatment Step

In the pretreatment step, the oxide containing R and Fe may be heat-treated in a reducing gas-containing atmosphere to obtain a partial oxide which is a partially reduced oxide.

### Reduction Step

In the reduction step, the partial oxide may be heated in the presence of a reducing agent at a temperature of at least 600° C. but not higher than 1300° C., preferably at least 700° C. but not higher than 1200° C., more preferably at least 800° C. but not higher than 1100° C. to obtain alloy particles. If the heating temperature is lower than 600° C., the reduction reaction of the oxide may not proceed. If the heating temperature is higher than 1300° C., R and Fe may melt into bulk form. Moreover, when the heating temperature is at least 700° C., the reduction time tends to be shortened, resulting in improved productivity. When the heating temperature is not higher than 1200° C., scattering of the reducing agent Ca tends to be reduced, resulting in further reduced variations during the reduction. The particle size of the rare earth-iron-based magnetic powder may be controlled by controlling such a reduction temperature. Generally, the higher the reduction temperature, the larger the powder particle size. To more uniformly perform the reduction reaction, the heat treatment time is preferably shorter than 120 minutes, more preferably shorter than 90 minutes. The lower limit of the heat treatment time is preferably at least 10 minutes, more preferably at least 30 minutes.

### Nitridation Step

To obtain a nitrogen (N)-containing core region, the method may include nitriding the alloy particles obtained in the reduction step (nitridation step). The nitridation step enables the production of a high frequency magnetic powder with higher permeability. As the particulate precipitate obtained in the precipitation step described above is used, the alloy particles obtained in the reduction step are in porous bulk form. This allows the alloy particles to be directly nitrided by heat treatment in a nitrogen atmosphere without grinding, resulting in uniform nitridation.

The heat treatment temperature in the nitridation of the alloy particles (hereinafter, nitridation temperature) is preferably at least 250° C. but not higher than 800° C., more preferably at least 300° C. but not higher than 600° C. Moreover, to increase the reaction efficiency by inhibiting decomposition of the nitridation reaction product in the nitridation step to be performed later, the nitridation is particularly preferably performed within a temperature range of at least 400° C. but not higher than 550° C. in an atmosphere substituted with nitrogen. The heat treatment time may be selected such that the alloy particles can be sufficiently uniformly nitrided.

### α-Fe-Containing Region

The α-Fe-containing region is present outside the core region and contains α-Fe and at least one selected from the group consisting of oxides, nitrides, and oxynitrides of the rare earth R. The α-Fe-containing region can increase the insulation between the adjacent magnetic powder particles, thereby reducing a decrease in efficiency caused by inter-particle eddy currents. Therefore, the use of the magnetic powder of the present disclosure enables the production of a magnetic material for magnetic field amplification having further improved tan δ and phase angle θ in a high frequency range and higher efficiency. Moreover, the α-Fe-containing region can magnetically couple the adjacent magnetic powder particles to reduce the demagnetizing field. Therefore, the use of the magnetic powder of the present disclosure tends to further improve the real part μ′ of the permeability of the magnetic material for magnetic field amplification. The α-Fe-containing region can be formed, for example, by forming a phosphorus compound coating portion on the surface of the magnetic powder and then heat-treating it in an oxygen-containing atmosphere.

The α-Fe-containing region preferably contains a compound containing at least one selected from the group consisting of oxides, nitrides, and oxynitrides of the rare earth R, and a nanocrystal including an α-Fe phase. The α-Fe-containing region more preferably contains a nanocrystal including at least one selected from the group consisting of oxides, nitrides, and oxynitrides of the rare earth R. The presence of the nanocrystal including at least one selected from the group consisting of oxides, nitrides, and oxynitrides of the rare earth R can be confirmed by observing a halo around the strongest diffraction line of the compound (for example, around a diffraction angle 2θ of 20° to 30°) by XRD with a CuKα source, or by observing a ring inside a ring pattern which indicates an α-Fe phase in an electron diffraction image of the α-Fe-containing region. When R is Sm, for example, the oxides, nitrides, and oxynitrides of the rare earth R are samarium oxides, samarium nitrides, and samarium oxynitrides, respectively. The α-Fe-containing region may further contain a complex oxide, complex nitride, or complex oxynitride containing the rare earth R and iron, a carbon-containing substance such as a carbonitride, a boron-containing substance such as a boride, or the like to an extent that the magnetically coupling is not impaired. Among these, the complex oxide, complex nitride, or complex oxynitride may have a perovskite structure or a spinel structure. The structure containing a compound including at least one selected from the group consisting of oxides, nitrides, and oxynitrides of R, and a nanocrystal including α-Fe can be formed, for example, by forming a phosphorus compound coating portion on the surface of the magnetic powder and then heat-treating it in an oxygen-containing atmosphere, or by nitriding the magnetic powder and then annealing it.

The “α-Fe phase” is a cubic crystal with a bcc structure and mainly contains Fe. The α-Fe phase may also contain a ferromagnetic component such as Co or Ni. The total ferromagnetic component content is preferably not more than 50 at %. The α-Fe phase may also contain nitrogen or an M component that is Ti, V, Mo, Nb, W, Si, Al, Mn, Cr, or other metal, preferably in an amount that does not disrupt the bcc structure to avoid impairing the ferromagnetism of the α-Fe phase. For example, the amount of Si, if present, is preferably not more than 10 at %, and the amount of nitrogen, if present, is preferably not more than 5 at %. Further, the amount of boron, if present, is preferably not more than 12 at %, more preferably not more than 5 at %, and the amount of carbon, if present, is preferably not more than 12 at %, more preferably not more than 5 at %.

When the α-Fe-containing region contains a compound including at least one selected from the group consisting of oxides, nitrides, and oxynitrides of the rare earth R, and a nanocrystal including α-Fe, the α-Fe-containing region is considered to provide a higher electric insulation effect and a higher magnetic coupling effect. Herein, the term “electric insulation” means that the presence of the α-Fe-containing region or the like having high electrical resistance on the surface of the magnetic powder may block the conduction between the core regions of the adjacent magnetic powder particles, thereby preventing the generation of eddy currents across the core regions. Such electric insulation can reduce eddy current loss, thereby achieving “good efficiency”. Also, the term “magnetic coupling” as used herein means that the presence of the α-Fe-containing region or the like having high electrical resistance and ferromagnetism on the surface of the magnetic powder may produce ferromagnetic coupling or magnetostatic coupling between the adjacent core regions. Such magnetic coupling can reduce the local demagnetizing fields and thus weaken the demagnetizing field acting on the core region, thereby achieving high relative permeability.

The compound including at least one selected from the group consisting of oxides, nitrides, and oxynitrides of the rare earth R in the α-Fe-containing region preferably has an average particle size of at least 1 nm but less than 1000 nm, more preferably at least 1 nm but not more than 100 nm, still more preferably at least 1 nm but not more than 20 nm, particularly preferably at least 1 nm but not more than 10 nm. The Fe-based nanocrystal with a bcc structure preferably has an average particle size of at least 1 nm but less than 1000 nm, more preferably at least 1 nm but not more than 100 nm, still more preferably at least 1 nm but not more than 20 nm, particularly preferably more than 1.5 nm but not more than 10 nm. The particle sizes can be measured on a cross-section of the α-Fe-containing rare earth-iron-based magnetic powder using a transmission electron microscope (TEM), a scanning transmission electron microscope (STEM), or an energy dispersive X-ray spectrometer (EDS) attached thereto.

Moreover, when the crystallite size of the Fe-based nanocrystal with a bcc structure is at least 1 nm but not more than 100 nm, and the peak of the nanocrystal can be separated from the peak of the core region, the crystallite size can be calculated from the full width at half maximum of the peak of the (110) plane measured by powder X-ray diffraction, using the Scherrer equation: D=Kλ/β cos θ (K: Scherrer constant 0.9, λ: X-ray wavelength (nm), β: full width at half maximum of diffraction peak (in radians), θ: bragg angle (in radians)). For example, the full width at half maximum of the crystal including an α-Fe phase may be measured using an X-ray source of CuKα at 40 kV and 15 mA in the diffraction angle range of 10<2 θ<90 with a step width of 20=0.01. For example, the measurement may be performed at a wavelength λ of 0.154 nm. Alternatively, the full width at half maximum of the crystal including an α-Fe phase may be measured using an X-ray source of CoKα at 40 kV and 135 mA in the diffraction angle range of 20<2 θ<110 with a step width of 20=0.01. For example, the measurement may be performed at a wavelength λ of 0.179 nm. In this case, the crystallite size determined using the Scherrer equation is preferably at least 1 nm but not more than 100 nm, more preferably at least 1 nm but not more than 20 nm, still more preferably at least 1 nm but not more than 15 nm, particularly preferably more than 1.5 nm but not more than 10 nm.

The atomic concentration (at %) of Fe in the entire α-Fe-containing region is preferably at least 25 at %, more preferably at least 40 at %. The upper limit of the atomic concentration of Fe is not limited, but it may be not higher than 80 at %. With an atomic concentration of Fe of at least 25 at %, the magnetic coupling tends to be maintained, resulting in a decrease in demagnetizing field and an increase in permeability.

The atomic concentration (at %) of the rare earth R in the entire α-Fe-containing region is preferably at least 1 at % but not more than 50 at %, more preferably at least 2 at % but not more than 30 at %. The atomic concentration (at %) of nitrogen in the entire α-Fe-containing region is preferably at least 0 at % but not more than 50 at %, more preferably at least 0.01 at % but not more than 30 at %. The atomic concentration (at %) of oxygen in the entire α-Fe-containing region is preferably at least 0 at % but not more than 55 at %, more preferably at least 0.01 at % but not more than 40 at %. The atomic concentration of each element in the α-Fe-containing region can be determined by averaging the atomic concentrations at each point in the region measured by STEM-EDS line analysis.

The average atomic concentration (at %) of oxygen (O) in the entire α-Fe-containing region is preferably higher than the average atomic concentration (at %) of oxygen (O) in the core region. The average atomic concentration of oxygen (O) in the α-Fe-containing region is preferably at least 1.05 times, more preferably at least 1.5 times, still more preferably at least 2 times, particularly preferably at least 2.5 times the average atomic concentration of oxygen (O) in the core region. Moreover, the average atomic concentration of the rare earth R in the α-Fe-containing region may be not more than 2 times, preferably not more than 1.9 times, more preferably not more than 1.8 times the average atomic concentration of the rare earth R in the core region. The average atomic concentration of the rare earth R in the α-Fe-containing region may be at least 0.1 times, preferably at least 0.5 times the average atomic concentration of the rare earth R in the core region. Here, the term “average atomic concentration” of a specific element refers to the atomic concentration determined by performing STEM-EDS line analysis on one or more line segments extending in the thickness direction from the core region to the outermost surface of the α-Fe-containing region of the α-Fe-containing rare earth-iron-based magnetic powder to measure the atomic concentrations of the element of at least 10 points and averaging them.

The thickness of the α-Fe-containing region is preferably at least 0.001% but less than 50%, more preferably at least 0.002% but not more than 45%, still more preferably at least 0.003% but not more than 35%, particularly preferably at least 0.01% but not more than 20% of the average particle size of the α-Fe-containing rare earth-iron-based magnetic powder. When the thickness is at least 0.001%, the electric insulation tends to be improved. When the thickness is less than 50%, the μ′ tends to increase due to the core region.

The α-Fe-containing region preferably has a thickness of at least 1 nm but not more than 80 μm, more preferably at least 2 nm but not more than 80 μm, still more preferably at least 3 nm but not more than 20 μm, further preferably at least 3 nm but not more than 10 μm, particularly preferably at least 5 nm but not more than 5 μm. To improve the μ′ in a high frequency range, the thickness may be at least 100 nm or at least 300 nm and may be not more than 1 μm. When the thickness is at least 1 nm, the electric insulation tends to be improved. When the thickness is not more than 10 μm, the μ′ tends to increase due to the core region. The thickness of the α-Fe-containing region can be measured by performing compositional analysis of a TEM, STEM, or SEM image of a cross-section of the α-Fe-containing rare earth-iron-based magnetic powder using TEM imaging or secondary electron or backscattered electron imaging or using line analysis, area analysis, or point analysis by EDS.

The surface coverage with the α-Fe-containing region of the core region is preferably at least 10%, more preferably at least 50%, still more preferably at least 80%, particularly preferably 100%. Increasing the surface coverage of the core region has the effect of increasing the electric insulation and improving the tan δ and the phase angle θ. In particular, a surface coverage of 100% can promote electrical isolation of the magnetic powder, thereby further increasing the above effect. The surface coverage with the α-Fe-containing region of the core region can be measured by observing a cross-section of the powder using a TEM, STEM, or SEM equipped with an EDS. The “surface coverage” is defined as the ratio of the length of the contact portion between the α-Fe-containing region and the core region to the entire circumferential length of the core region observed. Here, preferably, cross-sections of 20 to 50 particles of the magnetic powder in images observed as described above may be measured and averaged, and the average value may be taken as the surface coverage.

The α-Fe-containing region may have a structure in which nanocrystals of a ferromagnetic α-Fe phase are isolated in an oxide, nitride, or oxynitride phase containing at least one of the rare earth R and the M component, i.e., what is called a sea (an oxide, nitride, or oxynitride phase containing at least one of the rare earth R and the M component)-island (nano α-Fe phase) structure. In the α-Fe-containing region having a sea (an oxide, nitride, or oxynitride phase containing at least one of the rare earth R and the M component)-island (nano α-Fe phase) structure, each α-Fe metal phase is isolated in the “sea” which is a matrix phase of an oxide, nitride, or oxynitride containing at least one of the rare earth R and the M component. Thus, percolation of electrons does not occur, and the electric insulation is maintained. Moreover, the α-Fe phases may be regularly arranged in the α-Fe-containing region. In the α-Fe-containing region with regularly arranged α-Fe phases, the α-Fe phases can be included as crystal particles and can also be regularly arranged with a high density. Thus, the α-Fe phases may be ferromagnetically or magnetostatically coupled with each other to allow the magnetic flux to easily pass through the α-Fe-containing region, whereby the magnetic coupling also tends to be more stable.

Moreover, the α-Fe-containing region may have a sea-island structure including a sea region and an island region in which the island region has a higher atomic concentration (%) of X, a lower atomic concentration (%) of the rare earth R, and a lower atomic concentration (%) of oxygen (O) than the sea region. The atomic concentration (%) of X in the island region is preferably higher by at least 10 points, more preferably higher by at least 20 points than the atomic concentration (%) of X in the sea region. The atomic concentrations (%) of the rare earth R and oxygen (O) in the sea region are preferably higher by at least 2 points, more preferably higher by at least 5 points than the atomic concentrations (%) of the rare earth R and oxygen (O) in the island region, respectively. The atomic concentration (%) of each element in the island or sea region can be determined by averaging the atomic concentrations at each point in the region measured by STEM-EDS line analysis.

The presence or absence of an oriented crystalline phase as well as the size and the volume fraction of the oriented crystalline phase can be measured, for example, by observation of an STEM image of the α-Fe-containing rare earth-iron-based magnetic powder or by using an electron diffraction (ED) device attached to a TEM device. For example, in an STEM photograph of a cross-section of the α-Fe-containing rare earth-iron-based magnetic powder, a region that includes both the α-Fe phase and the oxide, nitride, or oxynitride phase containing at least one of the rare earth R and the M component and has lattice fringes in one direction is defined as “oriented region”, which can be subjected to image analysis. Five regions each including the α-Fe-containing region of the α-Fe-containing rare earth-iron-based magnetic powder (in the case of a thick α-Fe-containing region, the region may be divided into several fields of view) may be photographed with a scanning transmission electron microscope (STEM), and an “oriented region” may be compared with an unoriented region in each photographed region to determine the size and the volume fraction of the oriented crystalline phase. The presence or absence of an oriented crystal can also be determined from an electron diffraction pattern of a TEM-ED image.

### Phosphorus Compound Coating Portion

The α-Fe-containing rare earth-iron-based magnetic powder preferably includes a phosphorus compound coating portion, particularly to improve oxidation resistance. The phosphorus compound coating portion is preferably present outside the α-Fe-containing region, i.e., on a side opposite to the core region across the α-Fe-containing region.

To improve the tan δ and the phase angle θ of the magnetic material in a high frequency range, the thickness of the phosphorus compound coating portion is preferably at least 1 nm but not more than 200 nm, more preferably at least 2 nm but not more than 50 nm. Here, the thickness of the coating portion can be measured by performing compositional analysis of a TEM, STEM, or SEM image of a cross-section of the α-Fe-containing rare earth-iron-based magnetic powder using line analysis, area analysis, or point analysis by EDS. In the measurement using line analysis, etc., a region where the atomic concentration of phosphorus (P) observed is at least 1 at %, for example, may be regarded as the phosphorus compound coating portion. An example is a structure in which the phosphorus compound coating portion covers the entire surface (surface coverage 100%) of the α-Fe-containing rare earth-iron-based magnetic powder. In this case, the adjacent magnetic powder particles are considered to be completely electrically insulated from each other. In other words, this structure can have the effect of reducing iron loss due to inter-particle eddy currents by the phosphorus compound coating portion and can further improve the tan δ and the phase angle θ in a high frequency range to provide a magnetic material for magnetic field amplification with higher efficiency. Moreover, when the phosphorus compound coating portion has a thickness of not more than 10 nm, the α-Fe-containing region can be ferromagnetically coupled with the iron oxide-containing region containing magnetite or maghemite through this layer. Such magnetic coupling can reduce the local demagnetizing fields and thus further weaken the demagnetizing field acting on the core region, thereby achieving high relative permeability.

Examples of the phosphorus compound included in the phosphorus compound coating portion include phosphoric acid compounds such as inorganic phosphoric acids such as orthophosphoric acid, pyrophosphoric acid, and polyphosphoric acid, and phosphates of these inorganic phosphoric acids with Na, Ca, Pb, Zn, Fe, R, ammonium, Mo, W, V, Cr, etc. (herein, these metal elements or atomic groups may be referred to as phosphate-forming components); and “phosphorus-containing amorphous compounds” and “phosphorus-containing nanocrystalline compounds” which contain at least one selected from the rare earth R, an X component that is Fe, Co, or Ni, phosphate-forming components, and N with P and/or a phosphorus-containing substance. Among these, phosphates, “phosphorus-containing amorphous compounds”, and “phosphorus-containing nanocrystalline compounds” are preferred, for example, to form a dense surface coating on the powder including the core region and the α-Fe-containing region. The “phosphorus-containing nanocrystalline compounds” may be rare earth phosphates or may be in the form of eutectic or mixed crystals containing a rare earth phosphate and at least one selected from phosphates of an X component that is Fe, Co, or Ni and phosphates formed by combining phosphate-forming components with phosphoric acid. The presence of a “phosphorus-containing nanocrystalline compound” provides better thermal stability, so that the high-frequency characteristics of the magnetic material tend not to readily deteriorate, even when the magnetic powder after phosphorus treatment undergoes a kneading step or heat-curing step in which high heat is applied in the production of a bonded magnetic material, which is described later. Further, this can contribute to high thermal stability and good efficiency of the final molded product. Here, the term “nanocrystalline compound” refers to a compound containing fine crystals of at least 1 nm but less than 1 μm. Phosphorus compounds containing fine crystals of less than 1 nm are considered to fall into compounds that do not have a nano-scale fine crystal structure but have an amorphous structure. The crystallinity of the phosphorus compound coating portion and the diameter of the fine crystals in the phosphorus compound coating portion can be determined by lattice image observation using a TEM method or by analysis using an electron diffraction (ED) device attached to a TEM device.

In the α-Fe-containing rare earth-iron-based magnetic powder including the phosphorus compound coating portion, the amount of the phosphorus compound, when assumed as a rare earth phosphate, is preferably at least 0.001% by mass but not higher than 4.5% by mass, more preferably at least 0.05% by mass but not higher than 2.5% by mass, most preferably at least 0.1% by mass but not higher than 2% by mass. When the amount is not higher than 4.5% by mass, the aggregation of the rare earth-iron-based magnetic powder may be reduced, which tends to reduce a decrease in relative permeability and at the same time reduce deterioration of tan δ or phase angle θ in a high frequency range. When the amount is at least 0.001% by mass, the electric insulation of the phosphorus compound coating portion can be further improved, which also tends to reduce a decrease in relative permeability and reduce deterioration of tan δ or phase angle θ in a high frequency range.

Moreover, the amount of phosphorus (P) element in the α-Fe-containing rare earth-iron-based magnetic powder is preferably at least 0.0005% by mass, more preferably at least 0.001% by mass, still more preferably at least 0.05% by mass. The amount of phosphorus of the α-Fe-containing rare earth-iron-based magnetic powder is preferably not higher than 4% by mass, more preferably not higher than 2% by mass, still more preferably not higher than 1% by mass.

To avoid a reduction in efficiency due to eddy currents, i.e., to prevent deterioration of tan δ or phase angle θ, the phosphorus compound preferably at least partially covers the surface of the powder including the core region and the α-Fe-containing region. The magnetic powder with a surface coverage of at least 10% can have a certain degree of eddy current-reducing effect, but the surface coverage is preferably at least 50%, more preferably at least 80%. A surface coverage of at least 10% tends to reduce inter-particle eddy currents and reduce deterioration of tan δ or phase angle θ. The α-Fe-containing rare earth-iron-based magnetic powder with 100% coverage with the phosphorus compound coating portion has higher insulation properties and thus can achieve a low tan δ and a high phase angle θ at high frequencies, depending on the composition, crystal structure, powder particle size, etc. of the magnetic powder.

The surface coverage with the phosphorus compound coating portion of the magnetic powder can be estimated by observing a cross-section of the magnetic powder using a TEM, STEM, or SEM equipped with an EDS. The “surface coverage” is defined as the ratio of the length of the contact portion of the phosphorus-containing coating layer to the entire circumferential length of the surface of the α-Fe-containing rare earth-iron-based magnetic powder observed. Here, preferably, cross-sections of 20 to 50 particles of the magnetic powder in images observed as described above may be measured and averaged, and the average value may be taken as the surface coverage.

The phosphorus compound coating portion present on the surface of the α-Fe-containing rare earth-iron-based magnetic powder may include a region (R rich region) in which the atomic concentration of a rare earth (R) is higher than the atomic concentration of the rare earth R in the rare earth-iron-based magnetic powder (core region). The atomic concentration of the rare earth R in the R rich region may be at least 1.05 times, preferably at least 1.1 times, more preferably at least 1.2 times, still more preferably at least 1.4 times the atomic concentration of the rare earth R in the core region. The atomic concentration of the rare earth R in the R rich region may also be, for example, not more than 4 times the atomic concentration of the rare earth R in the core region. Here, the R rich region includes a layer that shows the highest peak of phosphorus (P) in STEM-EDS line analysis of the α-Fe-containing rare earth-iron-based magnetic powder. The R rich region may have a thickness of, for example, at least 1 nm, preferably at least 3 nm but not more than 150 nm, more preferably at least 5 nm but not more than 100 nm, still more preferably at least 7 nm but not more than 80 nm. When the atomic concentration of the rare earth R in the R rich region is within the above range relative to the atomic concentration of R in the core region, the electrical resistivity tends to increase, resulting in higher relative permeability. The atomic concentration (at %) of each element in the R rich region can be determined by averaging the atomic concentrations of the element in the phosphorus compound coating portion measured by STEM-EDS line analysis.

The ratio of the total atomic concentration of the rare earth R to the total atomic concentration of the X component that is Fe, Co, or Ni (R/X) in the R rich region may be at least 0.05, preferably at least 0.1, more preferably at least 0.2. The upper limit of the ratio R/X in the R rich region may be not higher than 100, not higher than 20, or not higher than 10. The ratio R/X in the R rich region may also be higher than the ratio R/X in the core region. The ratio R/X in the R rich region may be at least one time, preferably at least 1.5 times, more preferably at least two times, still more preferably at least 2.5 times the ratio R/X in the core region. When the ratio R/X in the R rich region is within the above range, the atomic concentration of X in the vicinity of the core region tends to decrease, resulting in further improved water resistance.

The α-Fe-containing rare earth-iron-based magnetic powder may further include a Mo rich layer. In the Mo rich layer, Mo used to form the phosphorus compound coating portion is present at a higher concentration than in the iron oxide layer described later or in the α-Fe-containing region. The Mo rich layer is preferably present outside the α-Fe-containing region. In some cases, the presence of the Mo rich layer has the effect of increasing the strength of the coating layer to improve the corrosion resistance.

In the α-Fe-containing rare earth-iron-based magnetic powder including an Mo rich layer, the thickness of the Mo rich layer is preferably at least 0.01% but not more than 10%, more preferably at least 0.02% but not more than 1% of the average particle size of the α-Fe-containing rare earth-iron-based magnetic powder. The thickness of the Mo rich layer is also preferably at least 1 nm but not more than 1 μm, more preferably at least 2 nm but not more than 100 nm.

### Iron Oxide-Containing Region

The α-Fe-containing rare earth-iron-based magnetic powder further includes an iron oxide-containing region. The iron oxide-containing region is present outside the α-Fe-containing region, but it may be present outside the phosphorus compound coating portion or the Mo-rich layer. The iron oxide-containing region mainly includes an iron oxide phase containing magnetite or maghemite. The presence of the iron oxide-containing region containing magnetite (Fe₃O₄) or maghemite (γ-Fe₂O₃), which is a ferromagnetic material, outside the α-Fe-containing region tends to improve the permeability of the α-Fe-containing rare earth-iron-based magnetic powder.

The presence of the iron oxide-containing region in the α-Fe-containing rare earth-iron-based magnetic powder can be confirmed, for example, by observing a peak in a range in which the strong diffraction lines of magnetite do not overlap with the diffraction lines of the core region (for example, around a diffraction angle 2θ of 29° to 31° for the (220) plane or around a diffraction angle 2θ of 56° to 58° for the (511) plane) or around the strongest diffraction line of maghemite (for example, around a diffraction angle 2θ of 29° to 31° for the (220) plane or around a diffraction angle 2θ of 56° to 58° for the (511) plane) by XRD with a CuKα source. Maghemite and magnetite have the same tetragonal spinel crystal structure and also have lattice constants a of 0.835 nm and 0.840 nm, respectively, which are almost the same. Thus, they are difficult to distinguish by measuring the nano-scale phases by XRD. Therefore, in order to distinguish maghemite from magnetite, it is necessary to: (1) measure the valence of Fe by X-ray photoelectron spectroscopy (XPS); or (2) extract the extended X-ray absorption fine structure (XAFS) oscillations from the X-ray absorption fine structure (XAFS) spectra and compare radial distribution functions obtained by Fourier transforming the oscillations. When comparing the electromagnetic properties of maghemite and magnetite, maghemite has a volume resistivity of 10⁶ Ωm and a magnetization of 0.42 T while magnetite has a volume resistivity of 4×10⁻⁵ Ωm and a magnetization of 0.60 T. Thus, maghemite is slightly inferior to magnetite in terms of magnetization, but it has high electric resistance. Magnetite is superior to maghemite in terms of magnetic coupling, while maghemite is advantageous in terms of electric insulation. Therefore, when it is desired to achieve good efficiency rather than high permeability, the magnetite previously formed outside the α-Fe-containing region may be heat-treated in an oxygen-containing atmosphere at a temperature of at least 200° C. but not higher than 600° C., e.g., by hydrogen annealing, to oxidize and convert the magnetite to maghemite.

The iron oxide-containing region preferably mainly contains maghemite and/or magnetite. In other words, it preferably does not contain hematite or does not mainly contain hematite. For example, when the core region contains a rare earth-iron-nitrogen-based compound, and the resulting magnetic powder has an XRD diffraction pattern in which the ratio (I)/(II) of the diffraction peak intensity (I) of the (104) plane of hematite to the diffraction peak intensity (II) of the (511) plane of magnetite or maghemite is at least 0 but lower than 10, the loss due to the electric insulation effect of hematite can be improved, and the magnetic coupling effect of maghemite and/or magnetite can also be expected, resulting in markedly improved permeability. If the peaks cannot be distinguished by XRD, the ratio may be calculated based on the presence and composition ratio of iron oxides determined from the values quantified by EDS analysis of a TEM, STEM, or SEM image of a cross-section of the α-Fe phase-containing rare earth-iron-based magnetic powder.

The iron oxide-containing region may contain a metal phase or intermetallic compound phase with a high electrical conductivity, such as an α-Fe phase, a cementite phase, or an Fe₃B phase. Preferably, such a phase is not present on the outermost surface. The presence of such a phase on the outermost surface is not preferred because eddy currents may occur in the entire material, extremely deteriorating the efficiency. The thickness of the phase is preferably at least 0.2 nm but not more than 10 μm, more preferably at least 1 nm but not more than 1 μm, still more preferably at least 1 nm but not more than 100 nm. When the thickness is within the above range, a decrease in efficiency due to eddy currents can be reduced.

The thickness of the iron oxide-containing region is preferably at least 0.01% but not more than 10%, more preferably at least 0.05% but not more than 2% of the average particle size of the α-Fe-containing rare earth-iron-based magnetic powder. When the thickness is within such a range, the ferromagnetic coupling between the magnetic powder particles tends to increase to reduce the demagnetizing field, so that the μ′ tends to increase. Moreover, the thickness of the iron oxide-containing region is preferably more than 0 nm but not more than 1 μm, more preferably at least 1 nm but not more than 100 nm. The iron oxide-containing region having a thickness of not more than 1 μm tends to reduce a decrease in μ′. The thickness of the iron oxide-containing region can be measured by performing compositional analysis of a TEM, STEM, or SEM image of a cross-section of the α-Fe-containing rare earth-iron-based magnetic powder using line analysis, area analysis, or point analysis by EDS.

The amount of magnetite or maghemite in the α-Fe-containing rare earth-iron-based magnetic powder is preferably at least 0.005% by mass but not more than 0.15% by mass, more preferably at least 0.01% by mass but not more than 0.1% by mass. When the amount is within such a range, the iron oxide-containing region tends to be uniformly formed on the surface of the α-Fe-containing rare earth-iron-based magnetic powder.

The iron oxide-containing region at least partially covers the surface of the powder including the core region and the α-Fe-containing region. The surface coverage with the iron oxide-containing region of the magnetic powder is preferably at least 25%, more preferably at least 75%. A surface coverage within such a range tends to lead to more improvements in both tan δ and μ′. The α-Fe-containing rare earth-iron-based magnetic powder with 100% coverage with the iron oxide-containing region can materialize complete electric insulation and magnetic coupling and can achieve high permeability and high efficiency compared to that with a coating different from the iron oxide-containing region in the present application, such as a hematite iron oxide coating layer. The surface coverage with the iron oxide-containing region of the magnetic powder can be estimated by observing a cross-section of the magnetic powder using a TEM, STEM, or SEM equipped with an EDS. The “surface coverage” is defined as the ratio of the length of the contact portion of the coating layer containing magnetite or maghemite to the entire circumferential length of the surface of the α-Fe-containing rare earth-iron-based magnetic powder observed. Here, preferably, cross-sections of 20 to 50 particles of the magnetic powder in images observed as described above may be measured and averaged, and the average value may be taken as the surface coverage.

The iron oxide-containing region may contain, in addition to magnetite or maghemite, Ni, Co, or an M component (at least one selected from the group consisting of Ti, V, Mo, Nb, W, Si, Al, Mn, and Cr) each derived from the core region or the additive used in the phosphorus treatment, or Na, Mg, Ca, K, Cu, Pb, Zn, Zr, Mo, Ba, Hf, Ta, La, Y, Ce, Pr, Nd, Gd, Tb, Dy, Ho, Er, Tm, Lu, or Sm each added in the phosphorus treatment. In this case, an M component-containing substance with a spinel structure of magnetite is called “M-ferrite”, but in the present disclosure it is considered to fall into magnetite because the M component content is as low as lower than 16.5 at %. Maghemite has the same spinel crystal structure as magnetite, and maghemite has a structure in which voids occupy one-sixth of the octahedral volume (octahedral site) of the spinel-type crystal structure. Therefore, as the crystal structure of the intermediate between magnetite and maghemite described in N. Imaoka, E. Kakimoto, K. Takagi, K. Ozaki, M. Tada, T. Nakagawa, M. Abe, Journal of Magnetism and Magnetic Materials, vol. 476, pp. 613 to 621 (2019) is also a spinel-type crystal structure, the intermediate is considered as a kind of magnetite in the present disclosure.

Further, the iron oxide-containing region may contain carbon or boron derived from the core region or other source.

The α-Fe-containing rare earth-iron-based magnetic powder including the iron oxide-containing region can be produced by any method. For example, it may be produced by a method including an annealing step which includes heat-treating the oxidized rare earth-iron-based magnetic powder having a phosphorus compound coating portion at a temperature of at least 350° C. but not higher than 600° C. in an atmosphere containing an inert gas or a nitrogen atom-free reducing gas, as described later.

### Particle Size of Magnetic Powder

The average particle size of the α-Fe-containing rare earth-iron-based magnetic powder is preferably at least 0.1 μm but not more than 100 μm, more preferably at least 0.5 μm but not more than 50 μm. If the average particle size is less than 0.1 μm, the amount of the magnetic powder filled in the molded product may be reduced, so that the real part of the relative permeability in a high frequency range may decrease. Consequently, the magnetic material properties tend to be extremely deteriorated. If the average particle size is more than 50 μm, the μ″ of the molded product tends to decrease. This tendency is more significant when the average particle size is more than 100 μm. Here, the average particle size refers to the median diameter measured under dry conditions using a laser diffraction particle size distribution analyzer. Specifically, the average particle size of the magnetic powder in the present disclosure is defined as D50, which represents the particle size corresponding to 50% of the cumulative particle size distribution by volume of the α-Fe-containing rare earth-iron-based magnetic powder.

As the particle size of the core region of the α-Fe-containing rare earth-iron-based magnetic powder increases, eddy currents may start to occur in the particles at a lower frequency due to the skin effect. Thus, with a larger particle size, the real part of the relative permeability may start to decrease in a lower frequency range. Therefore, the magnetic powder having a small particle size tends to maintain high magnetic field amplification characteristics even at high frequencies. For use as a magnetic material for magnetic field amplification, the upper limit of the particle size of the magnetic powder is preferably the particle size corresponding to a frequency f₀ (Hz) at which the real part of the relative permeability starts to decrease. Meanwhile, as the particle size decreases, the amount of the magnetic powder filled in the molded product decreases and the specific surface area also increases. Thus, for example, when the phosphorus compound coating portion has a thickness of 10 nm, the relative permeability may be reduced only by about 50% if the particle size of the powder is 0.1 μm, but the relative permeability may be about 6% if the particle size is 0.05 μm. Therefore, the lower limit of the particle size of the core region of the α-Fe-containing rare earth-iron-based magnetic powder in the present disclosure should be around 0.1 μm, regardless of the frequency. In consideration of the above-described tradeoff, the particle size is preferably adjusted to a range that is more suitable for the target frequency range of the magnetic powder.

### Magnetic Material for Magnetic Field Amplification

A magnetic material for magnetic field amplification according to the present embodiment contains the α-Fe-containing rare earth-iron-based magnetic powder. The magnetic material containing the α-Fe-containing rare earth-iron-based magnetic powder preferably has high relative permeability with a μ′ value of at least 11 in the frequency range of at least 1 MHz but lower than 10 MHz for magnetic field amplification.

The α-Fe-containing rare earth-iron-based magnetic powder preferably has a particle size of at least 0.1 μm but not more than 100 μm because, as described earlier, if a powder having a particle size of more than 100 μm is used in a magnetic material for magnetic field amplification at 1 MHz or higher, the relative permeability tends to decrease due to the skin effect. Further, when a powder of at least 10 μm is used in a magnetic material for magnetic field amplification, since a high pressure of at least 0.5 GPa is usually applied to increase the volume fraction, the powder particles may come into contact with each other and cause a large eddy current loss, thereby greatly reducing the real part of the relative permeability. Therefore, it is preferred that a fine and moderately soft substance such as a phosphorus compound, which is not as hard as ferrite or oxides of transition metals and not as soft as resins, coats the α-Fe-containing rare earth-iron-based magnetic powder or is present between the particles of the magnetic powder. This can reduce deterioration of the inherent properties such as relative permeability of the magnetic powder.

The magnetic material for magnetic field amplification can be suitably used at a frequency of at least 1 MHz but lower than 1 GHz. Therefore, depending on the composition, particle size distribution, etc. of the α-Fe-containing rare earth-iron-based magnetic powder, the imaginary part of the relative permeability may start to increase in a frequency range of at least 0.5 GHz but lower than 1 GHz. The magnetic material for magnetic field amplification according to the present embodiment may be used in a range of at least 1 MHz but lower than 0.5 GHz, preferably at least 1 MHz but lower than 0.1 GHz. The use of the magnetic material as a magnetic material for magnetic field amplification in the above frequency range is preferred in terms of the balance between cost and properties because a powder of at least 3 μm but not more than 100 μm can be used without using a fine grinding machine such as a jet mill, and also it is not necessary to perform magnetic field orientation or other processes which can reduce the throughput.

Examples of more specific applications of the magnetic material for magnetic field amplification include magnetic materials for magnetic field amplification or for hyper-high frequency absorption for use in wireless power transfer coils, antennas, or couplers operable at 6 MHz to 6 GHz, magnetic materials for magnetic field amplification for radio frequency identification (RFID) tags operable at at least 10 MHz but lower than 1 GHz, particularly at a high frequency of 920 MHz, and transformers, inductors, and reactors of circuits for high frequencies higher than 20 MHz. For example, the magnetic material may be used as a magnetic material for magnetic field amplification as follows. The magnetic material may be prepared in the form of a thin sheet and attached to the back of an antenna or a receiver/transmitter to concentrate the magnetic flux in the sheet by its magnetic field amplification characteristics; alternatively, the magnetic material may be inserted into the inside of a cylindrical or rectangular parallelepiped coil, or a conducting wire may be wound around a donut-shaped magnetic core or a magnetic core with a yoke to improve the real part of the relative permeability of the coil. Further, the magnetic material can also be used in applications such as magnetic inks, which form a magnetic circuit of a coil or the like, by applying or injecting it onto the surface or inside an electronic circuit.

Magnetic Metal and/or Metal Oxide

The magnetic material for magnetic field amplification of the present embodiment preferably contains a magnetic metal and/or metal oxide in addition to the α-Fe-containing rare earth-iron-based magnetic powder. Here, the magnetic metal may be an alloy, and the magnetic metal oxide may be a composite oxide. It should be noted that the magnetic metal and/or metal oxide are usually present in the form of powder or particles in the magnetic material for magnetic field amplification.

When a magnetic metal and/or metal oxide is introduced into the voids between the α-Fe-containing rare earth-iron-based magnetic powder particles while maintaining electrical insulation between the rare earth-iron-based soft magnetic material, which constitutes the core region of the α-Fe-containing rare earth-iron-based magnetic powder, and the magnetic metal and/or metal oxide, the demagnetizing field of the soft magnetic material powder can be reduced, thereby increasing the real part μ′ of the complex relative permeability. The presence of the magnetic metal and/or metal oxide increases the volume fraction of magnetic components, thereby improving the relative permeability. However, the rate of improvement (i.e., the increase in relative permeability) is not directly proportional to the volume fraction of magnetic components, but rather increases in a hyperbolic manner. This is considered to be due to the reduction of the demagnetizing field. The rate of improvement in relative permeability caused by the demagnetizing field tends to increase sharply as the volume fraction of magnetic components, including the magnetic metal and/or metal oxide, increases, i.e., as it approaches one.

Examples of the magnetic metal include Fe (preferably carbonyl iron), Ni, Co, Fe—Ni-based alloys, Fe—Ni—Si-based alloys, Sendust, Fe—Si—Al-based alloys, Fe—Si—Cr alloys, Fe—Cu—Nb—Si-based alloys, amorphous alloys, and the like. Examples of the magnetic metal oxide include spinel-type ferrites such as maghemite, magnetite, Ni ferrite, Zn ferrite, Mn—Zn ferrite, Ni—Zn ferrite, and Ni—Mn ferrite, as well as garnet-type ferrites and magnetoplumbite-type ferrites. To further improve the magnetic field amplification characteristics of the magnetic material, the magnetic metal and/or metal oxide added to the magnetic material for magnetic field amplification is preferably at least one selected from Ni, Fe (preferably carbonyl iron), or magnetite (Fe₃O₄).

When applied to the magnetic material for magnetic field amplification, the magnetic metal and/or metal oxide may have any average particle size, but the average particle size is preferably at least 1 nm but not more than 100 μm, more preferably at least 2 nm but not more than 50 μm, still more preferably at least 3 nm but not more than 20 μm. If the average particle size of the magnetic metal and/or metal oxide exceeds 100 μm, the losses in a high frequency range due to eddy current loss may increase, potentially degrading the magnetic field amplification characteristics. If the average particle size of the magnetic metal and/or metal oxide is less than 1 nm, moldability may deteriorate, or aggregation of the metal and/or metal oxide may easily occur, thereby potentially failing to fully utilize the inherent affinity and functional effects of the small particle size powder of the metal and/or metal oxide on the rare earth-iron-based soft magnetic powder, such as enhancing the dispersibility of the rare earth-iron-based soft magnetic powder. Here, an average particle size of 0.1 μm or more refers to the median diameter measured under dry conditions using a laser diffraction particle size distribution analyzer, while an average particle size of less than 0.1 μm refers to the median diameter measured under wet conditions using a dynamic light scattering particle size distribution analyzer. Moreover, for magnetic materials such as compounds or molded products, an alternative method may be used, which involves determining the median diameter from the volume-based particle size distribution obtained by measuring the particle sizes of 20 or more, preferably 50 or more, powder particles that sufficiently represent the overall sample in a microscopic image such as a TEM, STEM, or SEM image. In the above, the average particle size can be expressed as D50, which refers to the particle size corresponding to 50% of the cumulative particle size distribution by volume of the magnetic metal and/or metal oxide powder.

The shape of the magnetic metal and/or metal oxide is not limited and may be, for example, spherical, plate-like, flat, flaky, needle-like, fibrous, irregular, or any other shape. Usually, however, a spherical shape is preferred in order to ensure that the magnetic metal and/or metal oxide are present uniformly at the grain boundaries of the rare earth-iron-based soft magnetic powder particles, making them magnetically isotropic.

It is desirable that the particles of the magnetic metal and/or metal oxide be positioned as close to each other as possible, even if a thin insulating layer is present on their surfaces. In such cases, the demagnetizing field can be reduced, thereby increasing the real part μ′ of the complex relative permeability. Thus, when an additional non-magnetic component (such as an insulating layer) is attached to the magnetic metal and/or metal oxide, the ratio of the volume of the magnetic metal and/or metal oxide to the total volume is preferably at least 10 vol %. To achieve a higher real part μ′ of the complex relative permeability, the ratio is more preferably at least 25 vol %, still more preferably at least 50 vol %, and may even be 100 vol %.

In the magnetic material for magnetic field amplification, the amount (total amount) of the magnetic metal and/or metal oxide is preferably at least 0.1 parts by mass but not more than 100 parts by mass, more preferably at least 0.2 parts by mass but not more than 50 parts by mass, still more preferably at least 0.5 parts by mass but not more than 25 parts by mass, per 100 parts by mass of the rare earth-iron-based soft magnetic powder (the entire rare earth-iron-based soft magnetic powder, including the core region, the phosphorus compound coating portion, and the surface iron oxide-containing region). When the amount of the magnetic metal and/or metal oxide is at least 0.1 parts by mass per 100 parts by mass of the rare earth-iron-based soft magnetic powder, the addition of the magnetic metal and/or metal oxide can improve the filling ratio of the magnetic components per unit volume and reduce the demagnetizing field, which may result in a sufficient effect in increasing the real part μ′ of the complex relative permeability. Also, when the amount of the magnetic metal and/or metal oxide is not more than 100 parts by mass per 100 parts by mass of the rare earth-iron-based soft magnetic powder, a sufficient amount of the rare earth-iron-based soft magnetic powder in the composition can also be ensured. This allows the composition to exhibit better magnetic field amplification characteristics and particularly good efficiency, and the composition can therefore be suitably used in applications that require both high efficiency and high permeability, such as transformers and inductors used in the high frequency range.

The magnetic material for magnetic field amplification according to the present embodiment characteristically has a high real part of the relative permeability even in a high frequency range. For example, the real part of the relative permeability at a frequency of at least 1 MHz but not higher than 30 MHz is preferably at least 2, more preferably at least 5, still more preferably at least 10, while the real part of the relative permeability at a frequency of higher than 30 MHz but lower than 1 GHz is preferably at least 2, more preferably at least 4. Moreover, the magnetic material for magnetic field amplification according to the present embodiment may have a real part μ′ of the relative permeability at a frequency of, for example, 30 MHz that is at least 2.1, preferably at least 5.5, more preferably at least 10, still more preferably at least 10.5. The magnetic material for magnetic field amplification according to the present embodiment may have a real part μ′ of the relative permeability at a frequency of 20 MHz that is, for example, not more than 500 or not more than 200.

The magnetic material for magnetic field amplification according to the present embodiment preferably has a real part μ′ of the relative permeability at 10 MHz that is at least 11. Moreover, the tan δ (μ″/μ′) and the phase angle θ at 10 MHz are preferably not more than 0.1 and at least 84°, respectively, more preferably not more than 0.05 and at least 87°, respectively, still more preferably not more than 0.02 and at least 88°, respectively.

The magnetic material for magnetic field amplification according to the present embodiment also preferably has a real part of the relative permeability at 50 MHz that is at least 11. Moreover, the tan δ and the phase angle θ at 50 MHz may be not more than 0.2 and at least 78°, respectively. When the real part of the relative permeability, tan δ, and phase angle θ at 50 MHz are within the above respective ranges, the magnetic material can advantageously serve as a magnetic material for magnetic field amplification with a high magnetic field amplifying effect, good efficiency, and low cost, particularly when it is used around this frequency (for example, at least 20 MHz but not higher than 80 MHz). When the tan δ (μ″/μ′) and the phase angle θ are not more than 0.05 and at least 87°, respectively, the heat generated in the element or system into which the magnetic material is incorporated can be reduced to reduce the temperature of the components, etc. Thus, the stability tends to be improved.

The magnetic material for magnetic field amplification according to the present embodiment also preferably has a real part of the relative permeability at 100 MHz that is at least 11. Moreover, the tan δ and the phase angle θ at 100 MHz may be not more than 0.3 and at least 73°, respectively. When the real part of the relative permeability, tan δ, and phase angle θ at 100 MHz are within the above respective ranges, the magnetic material can advantageously serve as a magnetic material for magnetic field amplification with a high magnetic field amplifying effect, good efficiency, and low cost, particularly when it is used around this frequency (for example, at least 80 MHz but not higher than 120 MHz). When the tan δ (μ″/μ′) and the phase angle θ are not more than 0.2 and at least 78°, respectively, the heat generated in the element or system into which the magnetic material is incorporated can be reduced to reduce the temperature of the components, etc. Thus, the stability tends to be improved.

Here, the complex relative permeability, the tan δ, and the phase angle θ can be determined, for example, by measuring the impedance of a toroidal sample using an impedance analyzer, a (vector) network analyzer, or a BH analyzer, and then converting the result to the complex relative permeability, tan δ, or phase angle θ, or by using the S parameter method, depending on the frequency range (for example, when measured using a network analyzer at 500 MHz or higher). Specifically, the magnetic powder may be mixed with an epoxy resin, which is a thermosetting resin, such that the mixture has a magnetic powder content of 97% by mass, and then the mixture may be kneaded to prepare a resin compound. The resin compound may be charged into a mold having an inner diameter of 3.1 mm and an outer diameter of 8 mm, molded at an applied pressure of 0.8 GPa, and then heat-cured at 150° C. for two hours in vacuum to prepare a toroidal molded product as a sample. Using an impedance analyzer (E4991B, Keysight), the complex relative permeability of the sample in a frequency range of at least 1 MHz but not higher than 1 GHz may be evaluated from the inductance determined using a single-turn inductor-type test fixture.

The magnetic material for magnetic field amplification according to the present embodiment also characteristically has a relative permeability with low frequency dependence. For example, in a wireless power transfer application where the power is supplied at a frequency of 13.56 MHz, a magnetic material whose real part μ′ of the relative permeability varies only slightly in a frequency range including this frequency of at least 2 MHz but not higher than 20 MHz can exhibit good efficiency and is therefore suitable. Moreover, since many materials have a relative permeability that varies greatly even at 5 MHz or lower, the material having a stable real part of the relative permeability in a frequency range of at least 2 MHz but not higher than 20 MHz is also suitable for applications in this frequency range, etc. In these applications, a material whose μ′ varies greatly in the above frequency range also tends to have a correspondingly large deviation of μ″ from 0, resulting in deteriorated tan δ and phase angle θ.

The magnetic material for magnetic field amplification according to the present embodiment may contain a resin. A composite material of the magnetic material and a resin is referred to as a bonded magnetic material. The resin in the bonded magnetic material may be either a thermosetting resin or a thermoplastic resin. Examples of the thermoplastic resin include polyphenylene sulfides (PPS), polyether ether ketones (PEEK), liquid crystal polymers (LCP), polyamides (PA), polypropylenes (PP), polyethylenes (PE), and thermoplastic elastomers. Examples of the thermosetting resin include epoxy resins, phenolic resins, urea resins, melamine resins, guanamine resins, unsaturated polyester resins, vinyl ester resins, diallyl phthalate resins, polyurethane resins, silicone resins, polyimide resins, alkyd resins, furan resins, dicyclopentadiene resins, acrylic resins, allyl carbonate resins, and thermosetting elastomers commonly called rubbers.

The amount of the resin in the bonded magnetic material is preferably at least 0.1% by mass but not more than 95% by mass. When the amount of the resin component is at least 0.1% by mass, the impact resistance can be further improved. When the amount is not more than 95% by mass, a drastic decrease in relative permeability or magnetization can be reduced. Further, in applications which require the bonded magnetic material to have high relative permeability as well as impact resistance, the amount of the resin in the bonded magnetic material is more preferably in the range of at least 0.5% by mass but not more than 50% by mass for the reason described above. In applications such as high frequency circuit transformers with particularly good efficiency, the amount is most preferably in the range of at least 1% by mass but not more than 15% by mass. To allow the magnetic material for magnetic field amplification according to the present embodiment to have a particularly high real part of the relative permeability, the amount is also preferably not more than 15% by mass, although the amount may vary more or less depending on the application. A non-sinter-hardened molded product containing no resin, for example, a compact prepared with an auxiliary agent such as a volatile organic solvent, is very fragile and is extremely difficult to apply to, for example, a magnetic material for magnetic field amplification such as a wireless power transfer coil or an inductor magnetic core to which a load will be applied. Moreover, a molded product containing a lot of penetrating air spaces, such as a compact pressed at a pressure of not higher than 1.5 GPa, tends to be unsuitable for high-temperature applications because, when exposed to a temperature of at least 50° C. for a long time, it may be oxidized and degraded or become extremely fragile, resulting in deteriorated impact resistance. Thus, the amount of the resin in the molded product for these applications is preferably at least 0.1% by mass but not more than 95% by mass, more preferably at least 0.5% by mass but not more than 50% by mass, still more preferably at least 1% by mass but not more than 15% by mass.

The resin compound for the bonded magnetic material may be prepared, for example, by mixing and/or kneading the α-Fe-containing rare earth-iron-based magnetic powder and the resin using a kneading machine at a temperature of at least 180° C. but not higher than 300° C. For example, the α-Fe-containing rare earth-iron-based magnetic powder and the resin may be mixed using a mixer and then kneaded and extruded using a twin-screw extruder into a strand, which may then be cooled in the air and cut into a size of several millimeters using a pelletizer, thereby obtaining pellets of the resin compound for the bonded magnetic material.

The resin compound may be molded using an appropriate molding machine to produce the bonded magnetic material. Specifically, for example, the resin compound may be melted in the barrel of the molding machine and then injection-molded in the mold, to which a magnetic field is applied, to align the easy axes of magnetization (orientation step), thereby obtaining a magnetic field orientation-molded bonded magnetic material. Moreover, a bonded magnetic material sheet for magnetic field amplification or a bonded magnetic material sheet for hyper-high frequency absorption may be prepared by calendering or hot-pressing the pellets of the resin compound. The sheet may be rolled to a thickness of at least 20 μm but not more than 200 μm to produce a magnetic material for magnetic field amplification having a high real part of the relative permeability, which may be suitably used as, for example, a molded magnetic material sheet for magnetic field amplification for RFID tags.

### Magnetic Material for Hyper-High Frequency Absorption

A magnetic material for hyper-high frequency absorption according to the present embodiment contains a phosphorus compound and a rare earth-iron-nitrogen-based magnetic powder containing R, Fe, and N, where R represents at least one selected from the group consisting of Y, Ce, Pr, Nd, Gd, Tb, Dy, Ho, Er, Tm, Lu, and Sm, and if R includes Sm, Sm constitutes less than 50 at % of the total R content.

The magnetic material for hyper-high frequency absorption of the present embodiment containing the rare earth-iron-nitrogen-based magnetic powder and the phosphorus compound can have a high imaginary part of the relative permeability with a μ″ of at least 0.2 in a frequency range of 1 GHz to 0.11 THz and may also serve as a magnetic material for magnetic field amplification with a μ″ of at least 0.1 over most of the frequency range of at least 1 MHz but lower than 1 GHz. As the magnetic material for hyper-high frequency absorption of the present embodiment, any appropriate material may be used as long as it contains a phosphorus compound and a rare earth-iron-nitrogen-based magnetic powder containing R, Fe, and N, where R represents at least one selected from the group consisting of Y, Ce, Pr, Nd, Gd, Tb, Dy, Ho, Er, Tm, Lu, and Sm, and if R includes Sm, Sm constitutes less than 50 at % of the total R content. For example, the magnetic powder according to the embodiments described above may be used.

The rare earth-iron-nitrogen-based magnetic powder used in the magnetic material for hyper-high frequency absorption preferably has an average particle size of at least 0.1 μm but not more than 10 μm. The reason for this is as described above, and the relative permeability of a powder of at least 3 μm tends to be reduced in a hyper-high frequency range of at least 1 GHz due to the skin effect, and therefore the powder particle size should be at least 0.1 μm, if possible. Also, direct contact between the magnetic particles should be avoided as much as possible. For example, if a rare earth-iron-nitrogen-based magnetic powder of 30 μm is ground to a size of not more than 5 μm to be used as a magnetic material for hyper-high frequency absorption, the particles of the magnetic powder may come into contact with each other to be electrically connected during molding, and the electrically connected aggregates may have an average size of 30 μm. In this case, the effect of the particle size on high-frequency characteristics may be equal to that obtained when the unground powder is used, thus losing the purpose of grinding. Particularly, in the preparation of a magnetic sheet, which often uses a molding method such as hot pressing or calendering in which heat and pressure are simultaneously applied, it is preferred that an insulating layer such as a phosphorus compound be firmly adhered to the magnetic particle surface so that the magnetic particles are electrically insulated from each other even when the magnetic particles aggregate in the molded product matrix. A high frequency magnetic material with a high density and a high relative permeability can be produced by coating the surface of a magnetic powder, which easily aggregates, with a fine and moderately soft phosphorus compound, which is not as hard as ferrite or oxides of transition metals, and applying heat and pressure simultaneously.

The magnetic material for hyper-high frequency absorption according to the present embodiment characteristically has a high imaginary part μ″ of the relative permeability even at hyper-high frequencies. For example, the imaginary part μ″ of the relative permeability at a frequency of at least 1 GHz but lower than 20 GHz is preferably at least 0.2, more preferably at least 0.3. Moreover, the imaginary part μ″ of the relative permeability at a frequency of at least 20 GHz but not higher than 1 THz is preferably at least 0.1, more preferably at least 0.2. Moreover, for example, the magnetic material for hyper-high frequency absorption according to the present embodiment may have an imaginary part μ″ of the relative permeability at a frequency of 10 GHz that is at least 0.2, preferably at least 0.47, more preferably at least 0.5, still more preferably at least 0.55. The magnetic material for hyper-high frequency absorption according to the present embodiment may have an imaginary part μ″ of the relative permeability at a frequency of 10 GHz that is not more than 5 or not more than 4. Moreover, for example, the magnetic material for hyper-high frequency absorption according to the present embodiment may have an imaginary part μ″ of the relative permeability at a frequency of 0.11 THz that is at least 0.02, preferably at least 0.05, more preferably at least 0.1, still more preferably at least 0.2. The magnetic material for hyper-high frequency absorption according to the present embodiment may have an imaginary part μ″ of the relative permeability at a frequency of 0.11 THz that is not more than 2 or not more than 1.5. Furthermore, for example, the magnetic material for hyper-high frequency absorption according to the present embodiment preferably has a ratio of the imaginary part μ″ of the relative permeability at a frequency of 0.11 THz to the imaginary part μ″ of the relative permeability at a frequency of 10 GHz that is at least 0.03, more preferably at least 0.1. The magnetic material for hyper-high frequency absorption according to the present embodiment preferably has a ratio of the imaginary part μ″ of the relative permeability at a frequency of 0.11 THz to the imaginary part μ″ of the relative permeability at a frequency of 10 GHz that is not higher than 5, more preferably not higher than 1. When the magnetic material for hyper-high frequency absorption has a ratio of the imaginary part μ″ of the relative permeability at a frequency of 0.11 THz to the imaginary part μ″ of the relative permeability at a frequency of 10 GHz within the above range, it can exhibit higher absorption characteristics in a broad frequency band.

The magnetic material for hyper-high frequency absorption according to the present embodiment containing the rare earth-iron-nitrogen-based magnetic powder and the phosphorus compound can absorb hyper-high frequencies in a very broad frequency range of 1 GHz to 1 THz, and is distinct from magnetic materials which have a low relative permeability in a narrow frequency bandwidth of about 10 GHz, such as uniaxial magnetocrystalline anisotropic materials (e.g., hexagonal ferrites, borides, and epsilon iron oxide) which are expected to be used at such hyper-high frequencies. The presence of a phosphorus compound with high electrical resistivity in a magnetic powder is a key feature for planar magnetocrystalline anisotropic materials which have a lower electrical resistivity than oxide materials but have a higher resistance than metal materials and maintain the high-frequency characteristics at up to 1 THz.

Magnetic Metal and/or Metal Oxide

The magnetic material for hyper-high frequency absorption of the present embodiment may contain a magnetic metal and/or metal oxide in addition to the α-Fe-containing rare earth-iron-based magnetic powder. Here, the magnetic metal may be an alloy, and the magnetic metal oxide may be a composite oxide. It should be noted that the magnetic metal and/or metal oxide are usually present in the form of powder or particles in the magnetic material for hyper-high frequency absorption.

In the magnetic material for hyper-high frequency absorption, the amount (total amount) of the magnetic metal and/or metal oxide is preferably at least 0.1 parts by mass but not more than 100 parts by mass, more preferably at least 0.2 parts by mass but not more than 50 parts by mass, still more preferably at least 0.5 parts by mass but not more than 30 parts by mass, per 100 parts by mass of the rare earth-iron-based soft magnetic powder (the entire rare earth-iron-based soft magnetic powder, including the core region, the phosphorus compound coating portion, and the surface iron oxide-containing region). When the amount of the magnetic metal and/or metal oxide is at least 0.1 parts by mass per 100 parts by mass of the rare earth-iron-based soft magnetic powder, the addition of the magnetic metal and/or metal oxide can improve the filling ratio of the magnetic components per unit volume and reduce the demagnetizing field, which may result in a sufficient effect in increasing the real part μ′ of the complex relative permeability and improving the imaginary part μ″ of the complex relative permeability. Also, when the amount of the magnetic metal and/or metal oxide is not more than 100 parts by mass per 100 parts by mass of the rare earth-iron-based soft magnetic powder, a sufficient amount of the rare earth-iron-based soft magnetic powder in the composition can also be ensured. This allows the composition to exhibit better hyper-high frequency absorption characteristics.

Examples of the magnetic metal include Fe (preferably carbonyl iron), Ni, Co, Fe—Ni-based alloys, Fe—Ni—Si-based alloys, Sendust, Fe—Si—Al-based alloys, Fe—Si—Cr alloys, Fe—Cu—Nb—Si-based alloys, amorphous alloys, and the like. Examples of the magnetic metal oxide include spinel-type ferrites such as maghemite, magnetite, Ni ferrite, Zn ferrite, Mn—Zn ferrite, Ni—Zn ferrite, and Ni—Mn ferrite, as well as garnet-type ferrites and magnetoplumbite-type ferrites. To further improve the magnetic field amplification characteristics of the magnetic material, the magnetic metal and/or metal oxide added to the magnetic material for magnetic field amplification is preferably at least one selected from Ni, Fe (preferably carbonyl iron), or magnetite (Fe₃O₄).

Examples of more specific applications of the magnetic material for hyper-high frequency absorption include mobile communication equipment, mobile phone small base stations, and cloud base stations for 5th generation mobile communication systems (5G), 5th generation plus mobile communication systems (5G+), and 6th generation mobile communication systems (6G); components for absorbing hyper-high frequency signals and spurious signals for their infrastructure equipment such as apparatuses, devices, and antennas; components for absorbing hyper-high frequency signals and spurious signals for apparatuses and devices used in intelligent transport systems (ITS), wireless high-definition multimedia interface (HDMI) (registered trademark), wireless local area network (LAN), satellite broadcasting (Ka-band), etc.; and electromagnetic noise absorbing components for removing mainly the second to seventh harmonics in personal computers.

The magnetic material for hyper-high frequency absorption according to the present embodiment may contain a resin. The composite material of the magnetic material and the resin is referred to as a bonded magnetic material. The resin in the bonded magnetic material may be a thermosetting resin or a thermoplastic resin. Examples of the thermoplastic resin include polyphenylene sulfides (PPS), polyether ether ketones (PEEK), liquid crystal polymers (LCP), polyamides (PA), polypropylenes (PP), polyethylenes (PE), and thermoplastic elastomers. Examples of the thermosetting resin include epoxy resins, phenol resins, urea resins, melamine resins, guanamine resins, unsaturated polyester resins, vinyl ester resins, diallyl phthalate resins, polyurethane resins, silicone resins, polyimide resins, alkyd resins, furan resins, dicyclopentadiene resins, acrylic resins, allyl carbonate resins, and thermosetting elastomers commonly called rubbers.

The amount of the resin in the bonded magnetic material is preferably at least 0.1% by mass but not more than 95% by mass. When the amount of the resin component is at least 0.1% by mass, impact resistance can be further improved. When the amount is not more than 95% by mass, a drastic reduction in relative permeability or magnetization can be reduced. Further, in applications of the bonded magnetic material according to the present embodiment which require high relative permeability as well as impact resistance, the amount is more preferably at least 0.5% by mass but not more than 50% by mass for the reason described above. In applications such as a high frequency circuit transformer with particularly good efficiency, the amount is further preferably at least 1% by mass but not more than 15% by mass. To provide a magnetic material for magnetic field amplification according to the present embodiment with a particularly high real part of the relative permeability or a hyper-high frequency absorbing material with particularly good absorption characteristics, the amount is also preferably not more than 15% by mass, though it may vary more or less depending on the application. A non-sinter-hardened molded product containing no resin, for example, a compact which is prepared with an auxiliary agent such as a volatile organic solvent, is very fragile and thus is very difficult to apply to, for example, a magnetic field amplification material such as a wireless power transfer coil or an inductor magnetic core, to which a load will be applied, or a hyper-high frequency absorbing material mounted on a 5G+ or 6G mobile device which is frequently carried and often subjected to impact. Moreover, a molded product containing many penetrating air spaces, such as a compact pressed at a pressure of not higher than 1.5 GPa, tends to be unsuitable for applications at high temperatures because it may be oxidized and degraded or become very fragile when exposed to a temperature of at least 50° C. for a long time, resulting in deteriorated impact resistance. Thus, the amount of the resin in the molded product for these applications is preferably at least 0.1% by mass but not more than 95% by mass, more preferably at least 0.5% by mass but not more than 50% by mass, still more preferably at least 1% by mass but not more than 15% by mass.

The resin compound for the bonded magnetic material may be prepared, for example, by mixing and/or kneading the phosphorus compound, the rare earth-iron-nitrogen-based magnetic powder, and the resin, or the α-Fe-containing rare earth-iron-based magnetic powder and the resin using a kneading machine at a temperature of at least 180° C. but not higher than 300° C. For example, the α-Fe-containing rare earth-iron-based magnetic powder and the resin may be mixed using a mixer and then kneaded and extruded using a twin-screw extruder into a strand, which may then be cooled in the air and cut into a size of several millimeters using a pelletizer to obtain pellets of the resin compound for the bonded magnetic material according to the present embodiment.

The resin compound may be molded using an appropriate molding machine, whereby the bonded magnetic material according to the present embodiment can be produced. Specifically, for example, the resin compound may be melted in the barrel of a molding machine and then injection-molded in a mold, to which a magnetic field is applied, to align the easy axes of magnetization (orientation step), thereby obtaining a magnetic field orientation-molded bonded magnetic material. Moreover, a bonded magnetic material sheet for magnetic field amplification or a bonded magnetic material sheet for hyper-high frequency absorption may be prepared by calendering or hot pressing the pellets of the resin compound. The sheet may be rolled to a thickness of at least 20 μm but not more than 200 μm to produce a magnetic material for magnetic field amplification having a high real part of the relative permeability, which may be suitably used as, for example, a molded magnetic material sheet for magnetic field amplification for RFID tags and may be used as a molded magnetic material sheet for hyper-high frequency absorption for mobile devices.

As for other components and additives that may be added to the magnetic material for hyper-high frequency absorption as needed, those mentioned above as the other components and additives that may be added to the magnetic material for magnetic field amplification can be used. Moreover, the preferred amount ranges of these other components and additives in the magnetic material for hyper-high frequency absorption are also similar to those in the magnetic material for magnetic field amplification.

### Method of Producing α-Fe-Containing Rare Earth-Iron-Based Magnetic Powder

The method of producing an α-Fe-containing rare earth-iron-based magnetic powder according to the present embodiment includes:
performing a phosphorus treatment including adding an inorganic acid to a slurry containing: a rare earth-iron-based magnetic powder containing a rare earth R and Fe, where R represents at least one selected from the group consisting of Y, La, Ce, Pr, Nd, Pm, Eu, Gd, Tb, Dy, Ho, Er, Tm, Yb, Lu, and Sm; water; and a phosphorus-containing substance, to form a phosphorus compound coating portion on the magnetic powder, thereby obtaining a rare earth-iron-based magnetic powder having the phosphorus compound coating portion;
performing an oxidation including heat-treating the rare earth-iron-based magnetic powder having the phosphorus compound coating portion at a temperature of at least 350° C. but not higher than 600° C. in an oxygen-containing atmosphere; and
performing an annealing including heat-treating the oxidized rare earth-iron-based magnetic powder having the phosphorus compound coating portion at a temperature of at least 200° C. but not higher than 600° C. in an atmosphere containing an inert gas or a nitrogen atom-free reducing gas.

Since the method of the present embodiment includes an annealing step including heat-treating the oxidized rare earth-iron-based magnetic powder having the phosphorus compound coating portion at a temperature of at least 200° C. but not higher than 600° C. in an atmosphere containing an inert gas or a nitrogen atom-free reducing gas, it can provide an α-Fe-containing rare earth-iron-based magnetic powder that includes a core region, an α-Fe-containing region, and an iron oxide-containing region located outside the α-Fe-containing region and containing magnetite or maghemite.

When the rare earth-iron-based magnetic powder having the phosphorus compound coating portion is heat-treated at a temperature of at least 350° C. but not higher than 600° C. in an oxygen-containing atmosphere, an α-Fe-containing region can be formed, and also a surface structure in which the phosphorus compound coating portion is stacked outside the α-Fe-containing region can be produced. This structure can provide both the electric insulation and magnetic coupling described above and can simultaneously achieve high permeability and improved losses. Further, a hematite layer can also be formed outside the structure. This layer is effective in terms of further strengthening the electric insulation, but it may increase the volume fraction of the low magnetic parts and also increase the demagnetizing field of the entire magnetic powder, thereby failing to provide sufficiently high permeability. This layer can be heat-treated in an atmosphere containing an inert gas or a nitrogen atom-free reducing gas at a temperature of at least 200° C. but not higher than 600° C. to convert the weakly magnetic hematite to magnetite or maghemite, thereby imparting ferromagnetism to the outermost layer. Thus, the demagnetizing field of the entire magnetic powder can be greatly reduced.

Since both magnetite and maghemite exhibit ferromagnetism, they can be ferromagnetically coupled with the α-Fe-containing phase via the phosphorus compound coating portion to greatly mitigate the demagnetizing field of the magnetic parts, while allowing the phosphorus compound coating portion and the α-Fe-containing phase to provide electric insulation (this effect is greater with maghemite than with magnetite, as described later), resulting in unexpectedly high permeability and sufficient efficiency.

### Phosphorus Treatment Step

In the phosphorus treatment step, an inorganic acid may be added to a slurry containing a rare earth-iron-based magnetic powder, water, and a phosphorus-containing substance to form a phosphorus compound coating portion on the magnetic powder, thereby obtaining a rare earth-iron-based magnetic powder having the phosphorus compound coating portion. The rare earth-iron-based magnetic powder having the phosphorus compound coating portion may be formed by reacting the metal component (for example, X or a rare earth element) in the rare earth-iron-based magnetic powder with the phosphorus component (for example, phosphoric acid) in the phosphorus-containing substance to precipitate a phosphorus compound (for example, iron phosphate, samarium phosphate, cerium phosphate). Moreover, the phosphorus compound precipitated on the surface of the rare earth-iron-based magnetic powder preferably coats at least a part of the surface of the rare earth-iron-based magnetic powder (such coating is referred to as “phosphorus compound coating” or “phosphorus coating”, and the portion formed by such coating is referred to as “phosphorus compound coating portion”).

In the phosphorus treatment step, the use of water as a solvent allows the precipitated phosphorus compound such as phosphate to have a smaller particle size than that when using an organic solvent. Thus, the resulting magnetic powder has a dense phosphorus compound coating portion and tends to provide good efficiency in a high frequency range.

The slurry containing a rare earth-iron-based magnetic powder, water, and a phosphorus-containing substance can be prepared by any method, such as mixing a rare earth-iron-based magnetic powder with a phosphorus-containing substance solution containing a phosphorus-containing substance and water as a solvent. The amount of the rare earth-iron-based magnetic powder in the slurry is preferably at least 1% by mass but not more than 50% by mass. In view of productivity, the amount is more preferably at least 5% by mass but not more than 20% by mass. The amount of the phosphorus-containing substance in the slurry is not limited, but when the phosphorus-containing substance is phosphoric acid and consists only of hydrogen and the phosphate component PO₄, the amount of the phosphorus-containing substance, calculated as PO₄, is at least 0.01% by mass but not more than 10% by mass, for example. In view of reactivity between the metal component and the phosphate component and productivity, the amount is preferably at least 0.05% by mass but not more than 5% by mass.

Examples of the phosphorus-containing substance include elemental phosphorus and compositions thereof; phosphoric acid compounds such as orthophosphoric acid; heteropoly acid compounds such as phosphotungstic acid and phosphomolybdic acid; salts of phosphorus-containing acid compounds such as phosphoric acid compounds or heteropoly acid compounds with metal ions or ammonium ions; organic phosphorus compounds such as phosphate esters, phosphite esters, and phosphine oxides; and phosphorus-containing metals such as iron phosphide, phosphor bronze, Fe—B—P—Cu based alloys, and Fe—Nb—B—P based alloys.

When the phosphorus-containing substance is a phosphoric acid compound, an aqueous phosphate solution may be prepared by mixing the phosphoric acid compound with water. Examples of the phosphoric acid compound include orthophosphoric acid, sodium dihydrogen phosphate, sodium monohydrogen phosphate, ammonium dihydrogen phosphate, ammonium monohydrogen phosphate, zinc phosphate, calcium phosphate, and other phosphate compounds, hypophosphorous acid compounds, hypophosphite compounds, pyrophosphoric acid compounds, polyphosphoric acid compounds, and other inorganic phosphoric acids, and organic phosphoric acids, and salts thereof. These may be used alone or in combinations of two or more. To improve the water resistance and corrosion resistance of the coating portion and the magnetic properties of the magnetic powder, additives may also be used, including, for example, oxoacid salts such as molybdates, tungstates, vanadates, and chromates; oxidizing agents such as sodium nitrate and sodium nitrite; and chelating agents such as EDTA. In view of reaction control and coating amount control, phosphoric acid compounds including inorganic phosphoric acids such as orthophosphoric acid, pyrophosphoric acid, and polyphosphoric acid, and phosphates of these inorganic phosphoric acids with Na, Mg, Al, Ca, K, Ti, V, Cr, Mn, Ni, Cu, Pb, Zn, Fe, Zr, Mo, Ba, Hf, Ta, La, Y, Ce, Pr, Nd, Gd, Tb, Dy, Ho, Er, Tm, Lu, Sm, ammonium, etc. are preferred among the phosphorus-containing substances.

The phosphate concentration, calculated as PO₄, in the aqueous phosphate solution is preferably at least 5% by mass but not more than 50% by mass. In view of the solubility and storage stability of the phosphoric acid compound and ease of chemical conversion treatment, the phosphate concentration is more preferably at least 10% by mass but not more than 30% by mass. The pH of the aqueous phosphate solution is preferably at least 1 but not higher than 4.5. In order to facilitate the control of the precipitation rate of the phosphate, the pH is more preferably at least 1.5 but not higher than 4. The pH may be adjusted using dilute hydrochloric acid, dilute sulfuric acid, or the like.

In the phosphorus treatment step, when an inorganic acid is added to adjust the pH of the slurry, the amount of the precipitated phosphorus compound can be increased compared to when no inorganic acid is added. Thus, a magnetic powder with a coating portion having a large thickness (also referred to as layer thickness) can be obtained, resulting in improved tan δ and phase angle θ and therefore improved magnetic field amplification characteristics. The pH of the slurry is preferably adjusted to be at least 1 but not higher than 4.5, more preferably at least 1.6 but not higher than 3.9, still more preferably at least 2 but not higher than 3. If the pH is lower than 1, aggregation of the rare earth-iron-based magnetic powder particles tends to occur starting from the locally highly precipitated phosphorus compound, resulting in deteriorated tan δ and phase angle θ in a high frequency range. If the pH is higher than 4.5, the amount of the precipitated phosphorus compound such as phosphate tends to decrease, resulting in deteriorated tan δ and phase angle θ in a high frequency range. Examples of the inorganic acid to be added include hydrochloric acid, nitric acid, sulfuric acid, boric acid, and hydrofluoric acid. In the phosphorus treatment step, the inorganic acid is preferably added as needed to adjust the pH within the above-described range. Although the inorganic acid is used in view of liquid waste disposal, an organic acid may be used together depending on the purpose. Examples of the organic acid include acetic acid, formic acid, and tartaric acid.

The phosphorus treatment step may be performed such that the resulting magnetic powder has a phosphorus content of at least 0.0005% by mass. The phosphorus content of the magnetic powder obtained in the phosphorus treatment step is preferably at least 0.001% by mass, more preferably at least 0.05% by mass. The phosphorus content of the magnetic powder obtained in the phosphorus treatment step is preferably not higher than 4% by mass, more preferably not higher than 2% by mass, still more preferably not higher than 1% by mass. A phosphorus content of at least 0.0005% by mass tends to further increase the effect of the phosphorus compound coating. A phosphorus content of not higher than 4% by mass tends to reduce the deterioration of tan δ or phase angle θ in a high frequency range due to the aggregation of the magnetic powder particles starting from the phosphorus compound. To produce a magnetic material for magnetic field amplification with particularly good efficiency, the phosphorus content is preferably at least 0.05% by mass but not higher than 1% by mass. Here, the bulk phosphorus content of the total magnetic powder can be measured by ICP atomic emission spectroscopy (ICP-AES). Moreover, the local phosphorus contents of the magnetic powder phase and the phosphorus compound coating portion in the phosphorus compound-coated powder can be measured by STEM-EDS line analysis. Moreover, the atomic concentration of phosphorus (P) in the phosphorus compound coating portion is preferably at least 0.1 at %, more preferably at least 0.3 at %. The atomic concentration of P in the phosphorus compound coating portion may also be not more than 25 at %, preferably not more than 15 at %. If the phosphorus content of the phosphorus compound coating portion is less than 0.1 at %, the phosphorus compound tends not to easily function as an electric insulation. If the phosphorus content is more than 25 at %, the real part of the relative permeability in a high frequency range tends to decrease and the corrosion resistance performance also tends to decrease.

The phosphorus treatment step may be performed such that the phosphorus compound coating portion on the surface of the resulting magnetic powder has a region (R rich region) in which the atomic concentration of a rare earth (R) is higher than the atomic concentration of R in the rare earth (R)-iron-based magnetic powder. Examples of the rare earth (R) include Sm. In this case, the Sm rich region can be evaluated based on the atomic concentration of Sm.

The adjustment of the pH of the slurry containing a rare earth-iron-based magnetic powder, water, and a phosphorus-containing substance within the range of at least 1 but not higher than 4.5 is preferably performed for at least 10 minutes. To reduce the thin parts of the coating portion, the adjustment is more preferably performed for at least 30 minutes. In the pH maintenance, the pH initially increases rapidly, and thus the inorganic acid for pH control needs to be introduced at short intervals. Then, as the coating proceeds, pH fluctuations gradually decrease, which allows the inorganic acid to be introduced at longer intervals. In this way, the end point of the reaction can be determined.

Oxidation Step after Phosphorus Treatment

In this step, the rare earth-iron-based magnetic powder having the phosphorus compound coating portion may be heat-treated at a temperature of at least 350° C. but not higher than 600° C. in an oxygen-containing atmosphere. The oxidation treatment is considered to oxidize the surface of the rare earth-iron-based magnetic powder at the interface between the rare earth-iron-based magnetic powder and the phosphorus compound coating portion to form an α-Fe-containing region in which it has been disproportionated into an α-Fe phase and a phase including at least one selected from the group consisting of oxides, nitrides, and oxynitrides of the rare earth R. As a result, a magnetic material for magnetic field amplification having improved tan δ and phase angle θ in a high frequency range can be obtained.

In this step, an iron oxide layer may be precipitated from the phosphorus compound coating portion and deposited on the surface of the α-Fe-containing rare earth-iron-based magnetic powder. This iron oxide is often based on hematite. The iron oxide layer may also be bound to or released from the surface of the α-Fe-containing rare earth-iron-based magnetic powder. For use in applications requiring better efficiency, the iron oxide layer is preferably bound to the surface, and the iron oxide layer may be reduced in the subsequent annealing step to form an iron oxide-containing region based on maghemite and/or magnetite, thereby achieving high permeability and high efficiency. The iron oxide layer may contain at least one of Ni, Co, and the M component element.

The oxidation treatment may be performed by heat-treating the phosphorus-treated magnetic powder in an oxygen-containing atmosphere. The reaction atmosphere preferably contains oxygen in an inert gas such as nitrogen or argon. The oxygen concentration is preferably at least 3 vol % but not more than 25 vol %, more preferably at least 3.5 vol % but not more than 21 vol %. During the oxidation reaction, gas exchange is preferably performed at a flow rate of at least 2 L/min but not higher than 10 L/min per kg of the magnetic powder.

The temperature in the oxidation treatment varies depending on the composition of the core region and the surface coverage of the core region, and it is at least 300° C. but not higher than 600° C., preferably at least 320° C. but not higher than 580° C., more preferably at least 350° C. but not higher than 550° C., still more preferably at least 400° C. but not higher than 500° C. At lower than 300° C., the real part of the relative permeability in a high frequency range tends to decrease. At higher than 600° C., the magnetic powder tends to excessively decompose. The reaction time may be at least 30 minutes, at least one hour, or at least three hours. The reaction time may be not longer than 20 hours or not longer than 10 hours.

It is considered that when the phosphorus treatment step is followed by the oxidation step, excessive pyrolysis of the core region can be avoided so that an α-Fe phase can be gradually separated and dispersed at the nanoscale from the matrix by a disproportionation reaction of the surface of the rare earth-iron-based magnetic powder beneath the phosphorus compound coating portion.

### Annealing Step

In this step, the oxidized rare earth-iron-based magnetic powder having the phosphorus compound coating portion may be heat-treated at a temperature of at least 200° C. but not higher than 600° C. in an atmosphere containing an inert gas or a nitrogen atom-free reducing gas. This step is considered to reduce at least a portion of hematite formed on the surface of the α-Fe-containing rare earth-iron-based magnetic powder in the oxidation step to form an iron oxide-containing region containing magnetite or maghemite outside the α-Fe-containing region.

Examples of the inert gas in the heat treatment include Ar gas, N₂ gas, Ne gas, and He gas. Examples of the nitrogen atom-free reducing gas in the heat treatment include H₂ gas and CO gas. Mixture of the foregoing gases may also be used. The concentration of oxygen in the atmosphere in the heat treatment is preferably not more than 0.1 vol %, more preferably not more than 0.01 vol %.

The temperature in the heat treatment varies depending on the composition of the core region and the surface coverage of the core region, and it is at least 350° C. but not higher than 600° C., preferably at least 380° C. but not higher than 550° C., more preferably at least 400° C. but not higher than 480° C. At lower than 350° C., the treatment time tends to be very long. At higher than 600° C., the phosphorus compound coating tends to degrade. The reaction time may be at least 10 minutes, at least one hour, or at least three hours. The reaction time may be not longer than 20 hours, or not longer than six hours.

The annealing step including heat treatment at a temperature of at least 200° C. but not higher than 600° C. in an atmosphere containing an inert gas or a nitrogen atom-free reducing gas may be followed by heat treatment at a temperature of at least 200° C. but not higher than 600° C. in an oxygen-containing atmosphere. This heat treatment step can oxidize the magnetite formed outside the α-Fe-containing region into maghemite. The temperature in the heat treatment is preferably at least 200° C. but not higher than 600° C., more preferably at least 200° C. but not higher than 500° C., still more preferably at least 200° C. but not higher than 300° C.

### Silica Treatment Step

The magnetic powder obtained through the annealing step may optionally be subjected to a silica treatment. Forming a silica thin layer on the magnetic powder can improve the oxidation resistance. The silica thin layer may be formed, for example, by mixing an alkyl silicate, the magnetic powder, and an alkali solution.

### Silane Coupling Treatment Step

The silica-treated magnetic powder may be further treated with a silane coupling agent. When the magnetic powder provided with a silica thin layer is subjected to a silane coupling treatment, a silane coupling agent layer is formed on the silica thin film, which improves the magnetic properties of the magnetic powder as well as the wettability between the magnetic powder and the resin and the strength of the molded product. Any silane coupling agent may be used and may be selected depending on the resin type. Examples of the silane coupling agent include γ-(2-aminoethyl)aminopropyltrimethoxysilane, γ-(2-aminoethyl)aminopropylmethyldimethoxysilane, γ-methacryloxypropyltrimethoxysilane, γ-methacryloxypropylmethyldimethoxysilane, N-β-(N-vinylbenzylaminoethyl)-γ-aminopropyltrimethoxysilane hydrochloride, γ-glycidoxypropyltrimethoxysilane, γ-mercaptopropyltrimethoxysilane, methyltrimethoxysilane, methyltriethoxysilane, vinyltriacetoxysilane, γ-chloropropyltrimethoxysilane, hexamethylenedisilazane, γ-anilinopropyltrimethoxysilane, vinyltrimethoxysilane, octadecyl[3-(trimethoxysilyl)propyl]ammonium chloride, γ-chloropropylmethyldimethoxysilane, γ-mercaptopropylmethyldimethoxysilane, methyltrichlorosilane, dimethyldichlorosilane, trimethylchlorosilane, vinyltrichlorosilane, vinyltris(β-methoxyethoxy)silane, vinyltriethoxysilane, β-(3,4-epoxycyclohexyl)ethyltrimethoxysilane, γ-glycidoxypropylmethyldiethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, ureidopropyltriethoxysilane, γ-isocyanatopropyltriethoxysilane, polyethoxydimethylsiloxane, polyethoxymethylsiloxane, bis(trimethoxysilylpropyl)amine, bis(3-triethoxysilylpropyl)tetrasulfane, γ-isocyanatopropyltrimethoxysilane, vinylmethyldimethoxysilane, 1,3,5-N-tris(3-trimethoxysilylpropyl)isocyanurate, t-butyl carbamate trialkoxysilanes, and N-(1,3-dimethylbutylidene)-3-(triethoxysilyl)-1-propaneamine. These silane coupling agents may be used alone or in combinations of two or more. The amount of the silane coupling agent added per 100 parts by mass of the magnetic powder is preferably at least 0.2 parts by mass but not more than 0.8 parts by mass, more preferably at least 0.25 parts by mass but not more than 0.6 parts by mass. If the amount is less than 0.2 parts by mass, the effect of the silane coupling agent tends to be small. If the amount is more than 0.8 parts by mass, the magnetic properties of the magnetic powder or molded product tend to decrease due to aggregation of the magnetic powder.

Moreover, the silica treatment step and/or silane coupling treatment step may be replaced or followed by subjecting the magnetic powder to a surface treatment with a coupling agent, examples of which include titanium coupling agents such as isopropyl triisostearoyl titanate, isopropyl tri(N-aminoethyl-aminoethyl)titanate, isopropyl tris(dioctylpyrophosphate)titanate, tetraisopropyl bis(dioctylphosphite)titanate, tetraisopropyl titanate, tetrabutyl titanate, tetraoctyl bis(ditridecylphosphite)titanate, isopropyl trioctanoyl titanate, isopropyl tridodecylbenzenesulfonyl titanate, isopropyl tri(dioctylphosphate)titanate, bis(dioctylpyrophosphate)ethylenetitanate, isopropyl dimethacryl isostearoyl titanate, tetra(2,2-diallyloxymethyl-1-butyl)bis(ditridecylphosphite)titanate, and isopropyl tricumyl phenyl titanate, aluminum coupling agents such as acetoalkoxyaluminum diisopropylate, zirconium coupling agents, chromium coupling agents, iron coupling agents, and tin coupling agents. When the magnetic powder obtained through this treatment is used to prepare a bonded magnetic material, the affinity with the resin added may be improved, the dispersion and isolation of the α-Fe-containing rare earth-iron-based magnetic powder may become significant, and higher electric insulation between the powder particles may be provided, resulting in good efficiency in a high frequency range.

The magnetic powder obtained after the phosphorus treatment step, oxidation step, annealing step, silica treatment step, or silane coupling treatment step may be filtered, dehydrated, and dried in a usual manner.

The real part of the relative permeability of the α-Fe-containing rare earth-iron-based magnetic powder can be improved by uniformizing the particle size distribution. The uniformization of the particle size distribution can be carried out by a general dry or wet classification method. The uniformization of the particle size distribution may be performed at any time before the phosphate treatment, after the phosphorus treatment step, after the oxidation step, after the annealing step, after the silica treatment step, or after the silane coupling treatment step.

### EXAMPLES

The present disclosure is further specifically described with reference to, but not limited to, the following examples and other embodiments.

The evaluation methods performed in the examples are as described below.

### (1) XRD, α-Fe Peak Intensity Ratio, and Full Width at Half Maximum

The XRD pattern of the magnetic powder was measured with a powder X-ray crystal diffractometer (Minflex 600C, Rigaku Corporation, X-ray wavelength: CuKα) The measurement was performed under the conditions including an acceleration voltage of 40 kV and a tube current of 20 mA in the range of 10<2θ<90 with a step width of 2θ=0.01.

### (2) Average Particle Size

The average particle size of the magnetic powder was measured with a laser diffraction particle size distribution analyzer (MASTERSIZER 2000, MALVERN Inst.).

### (3) Measurement of Complex Relative Permeability (1 MHz to 1 GHz)

The magnetic powder was mixed with an epoxy resin (thermosetting resin) such that the magnetic powder content was 97% by mass and then kneaded to prepare a resin compound. The resin compound was charged into a mold having an inner diameter of 3.1 mm and an outer diameter of 8 mm, molded at an applied pressure of 0.8 GPa, and then heat-cured at 150° C. for two hours in vacuum to prepare a toroidal molded product as a sample. Using an impedance analyzer (E4991B, Keysight), the complex relative permeability of the sample in a frequency range of 1 MHz to 1 GHz was evaluated from the inductance determined using a single-turn inductor-type test fixture.

### (4) STEM-EDX Analysis and TEM-ED Analysis

The STEM analysis of the surface of the magnetic powder was performed as follows. First, the prepared magnetic powder was subjected to carbon coating followed by cross-sectioning and thin sectioning using a focused ion beam (FIB) to obtain a sample. The sample was measured with an STEM (JEOL Ltd., model No. JEM-F200, acceleration voltage: 200 kV) and an EDS (system: JEOL Ltd., model No. SD100HR, detector: dry SD detector, JEOL Ltd.) attached to the STEM.

### Comparative Example 1

A Nd₂Fe₁₇N₃ magnetic powder having an average particle size of about 15 μm was prepared from iron sulfate and neodymium sulfate as raw materials by a precipitation method as described below.

### Preparation of Nd—Fe Sulfuric Acid Solution

An amount of 5.0 kg of FeSO₄·7H₂O was mixed and dissolved in 2.0 kg of pure water. Then, 0.45 kg of Nd₂O₃ powder and 0.70 kg of 70% sulfuric acid were added and stirred well until they were completely dissolved. Next, pure water was added to the resulting solution so that the final Fe and Nd concentrations were adjusted to 0.726 mol/L and 0.106 mol/L, respectively, to give a Nd—Fe sulfuric acid solution.

### Precipitation Step

The entire amount of the prepared Nd—Fe sulfuric acid solution was added dropwise with stirring to 20 kg of pure water kept at a temperature of 40° C. over 70 minutes from the start of the reaction, while 15% ammonia water was added dropwise to adjust the pH to 7 to 8. Thus, a slurry containing a Nd—Fe hydroxide was obtained. The slurry was washed with pure water by decantation, followed by solid-liquid separation to separate the hydroxide. The separated hydroxide was dried in an oven at 100° C. for 10 hours.

### Oxidation Step

The hydroxide obtained in the precipitation step was fired in the air at 1030° C. for one hour and then cooled to obtain a red Nd—Fe oxide as a raw material powder.

### Pretreatment Step

An amount of 100 g of the Nd—Fe oxide was put in a steel vessel to a thickness of 10 mm. The vessel was placed in a furnace, and the pressure was reduced to 100 Pa. Then, while introducing hydrogen gas, the temperature was increased to a pretreatment temperature of 850° C. and maintained at this temperature for 15 hours to obtain a partial oxide as a black powder.

### Reduction Step

An amount of 60 g of the partial oxide obtained in the pretreatment step was mixed with 19.2 g of metallic calcium having an average particle size of about 6 mm, and the mixture was placed in a furnace. After vacuum evacuation of the furnace, argon gas (Ar gas) was introduced. The temperature was increased to 1045° C. and maintained for 45 minutes to obtain Fe—Nd alloy particles.

### Nitridation Step

Subsequently, the temperature inside the furnace was lowered to 100° C., followed by vacuum evacuation. Then, while introducing nitrogen gas, the temperature was increased to 450° C. and maintained at this temperature for 23 hours to obtain a magnetic powder-containing bulk product.

### Water Washing Step

The bulk product obtained in the nitridation step was introduced into 3 kg of pure water and stirred for 30 minutes. After standing still, the supernatant was drained by decantation. The introduction into pure water, stirring, and decantation were repeated 10 times. Then, 2.5 g of 99.9% acetic acid was introduced and stirred for 15 minutes. After standing still, the supernatant was drained by decantation. The introduction into pure water, stirring, and decantation were repeated twice, followed by dehydration, drying, and then mechanical crushing to obtain a Nd₂Fe₁₇N₃ magnetic powder (average particle size: about 15 μm).

### Phosphorus Treatment Step

A phosphate treatment liquid was prepared by mixing 85% orthophosphoric acid, sodium dihydrogen phosphate, and sodium molybdate dihydrate at a mass ratio of 1:6:1, respectively, and adding pure water and dilute hydrochloric acid to adjust the pH and the PO₄ concentration to 2 and 20% by mass, respectively. The Nd₂Fe₁₇N₃ magnetic powder obtained in the water washing step was stirred in dilute hydrochloric acid (water:hydrogen chloride=1000 g:70 g) for one minute to remove the oxidized surface layer and contaminants, followed by repeating draining and supplying water until the supernatant had a conductivity of not higher than 100 ρS/cm. Thus, a slurry containing 10% by mass of the Nd—Fe—N-based magnetic powder was obtained. Then, while stirring the slurry, 100 g of the prepared phosphate treatment liquid was entirely introduced into the treatment tank. Subsequently, 6% by mass hydrochloric acid was introduced as needed to control the pH of the phosphate treatment reaction slurry to fall within a range of 2.0±0.1, which was maintained for 40 minutes. Then, the slurry was subjected to suction filtration, dehydration, and vacuum drying to obtain a Nd—Fe—N-based magnetic powder having a phosphorus compound coating portion according to Comparative Example 1.

### Comparative Example 2

### Preparation of Nd—Fe Sulfuric Acid Solution

An amount of 5.0 kg of FeSO₄·7H₂O was mixed and dissolved in 2.0 kg of pure water. Then, 0.45 kg of Nd₂O₃ powder and 0.70 kg of 70% sulfuric acid were added and stirred well until they were completely dissolved. Next, pure water was added to the resulting solution so that the final Fe and Nd concentrations were adjusted to 0.726 mol/L and 0.106 mol/L, respectively, to give a Nd—Fe sulfuric acid solution.

### Precipitation Step

The entire amount of the prepared Nd—Fe sulfuric acid solution was added dropwise with stirring to 20 kg of pure water kept at a temperature of 40° C. over 70 minutes from the start of the reaction, while 15% ammonia water was added dropwise to adjust the pH to 7 to 8. Thus, a slurry containing a Nd—Fe hydroxide was obtained. The slurry was washed with pure water by decantation, followed by solid-liquid separation to separate the hydroxide. The separated hydroxide was dried in an oven at 100° C. for 10 hours.

### Oxidation Step

The hydroxide obtained in the precipitation step was fired in the air at 1030° C. for one hour and then cooled to obtain a red Nd—Fe oxide as a raw material powder.

### Pretreatment Step

An amount of 100 g of the Nd—Fe oxide was put in a steel vessel to a thickness of 10 mm. The vessel was placed in a furnace, and the pressure was reduced to 100 Pa. Then, while introducing hydrogen gas, the temperature was increased to a pretreatment temperature of 850° C. and maintained at this temperature for 15 hours to obtain a partial oxide as a black powder.

### Reduction Step

An amount of 60 g of the partial oxide obtained in the pretreatment step was mixed with 19.2 g of metallic calcium having an average particle size of about 6 mm, and the mixture was placed in a furnace. After vacuum evacuation of the furnace, argon gas (Ar gas) was introduced. The temperature was increased to 1045° C. and maintained for 45 minutes to obtain Fe—Nd alloy particles.

### Nitridation Step

Subsequently, the temperature inside the furnace was lowered to 100° C., followed by vacuum evacuation. Then, while introducing nitrogen gas, the temperature was increased to 450° C. and maintained at this temperature for 23 hours to obtain a magnetic powder-containing bulk product.

### Water Washing Step

The bulk product obtained in the nitridation step was introduced into 3 kg of pure water and stirred for 30 minutes. After standing still, the supernatant was drained by decantation. The introduction into pure water, stirring, and decantation were repeated 10 times. Then, 2.5 g of 99.9% acetic acid was introduced and stirred for 15 minutes. After standing still, the supernatant was drained by decantation. The introduction into pure water, stirring, and decantation were repeated twice, followed by dehydration, drying, and then mechanical crushing to obtain a Nd₂Fe₁₇N₃ magnetic powder (average particle size: about 15 μm).

### Phosphorus Treatment Step

A phosphate treatment liquid was prepared by mixing 85% orthophosphoric acid, sodium dihydrogen phosphate, and sodium molybdate dihydrate at a mass ratio of 1:6:1, respectively, and adding pure water and dilute hydrochloric acid to adjust the pH and the PO₄ concentration to 2 and 20% by mass, respectively. The Nd₂Fe₁₇N₃ magnetic powder obtained in the water washing step was stirred in dilute hydrochloric acid (water:hydrogen chloride=1000 g:70 g) for one minute to remove the oxidized surface layer and contaminants, followed by repeating draining and supplying water until the supernatant had a conductivity of not higher than 100 μS/cm. Thus, a slurry containing 10% by mass of the Nd—Fe—N-based magnetic powder was obtained. Then, while stirring the slurry, 100 g of the prepared phosphate treatment liquid was entirely introduced into the treatment tank. Subsequently, 6% by mass hydrochloric acid was introduced as needed to control the pH of the phosphate treatment reaction slurry to fall within a range of 2.0±0.1, which was maintained for 40 minutes. Then, the slurry was subjected to suction filtration, dehydration, and vacuum drying to obtain a Nd—Fe—N-based magnetic powder having a phosphorus compound coating portion.

An amount of 300 g of the Nd—Fe—N-based magnetic powder having a phosphorus compound coating portion was gradually heated from room temperature in an atmosphere of a gaseous mixture of nitrogen and air (oxygen concentration 4 vol %, 5 L/min) to perform heat treatment at 465° C. for four hours, thereby obtaining an oxidized Nd—Fe—N-based magnetic powder (average particle size: about 8 μm) according to Comparative Example 2.

### Example 1

The oxidized Nd—Fe—N-based magnetic powder of Comparative Example 2 was then gradually heated from room temperature in an argon atmosphere to perform heat treatment at 420° C. for four hours, thereby obtaining a Nd—Fe—N-based magnetic powder (average particle size: about 8 μm) according to Example 1.

### Example 2

A Nd—Fe—N-based magnetic powder (average particle size: about 8 μm) according to Example 2 was obtained by subjecting the oxidized Nd—Fe—N-based magnetic powder of Comparative Example 2 to the same treatment as in Example 1, except that the heat treatment atmosphere was changed from the argon atmosphere to a nitrogen atmosphere, and the heat treatment time was changed from four hours to 30 minutes.

### Example 3

A Nd—Fe—N-based magnetic powder (average particle size: about 8 μm) according to Example 3 was obtained by subjecting the oxidized Nd—Fe—N-based magnetic powder of Comparative Example 2 to the same treatment as in Example 1, except that the heat treatment atmosphere was changed from the argon atmosphere to a hydrogen atmosphere, and the heat treatment time was changed from four hours to 15 minutes.

### Comparative Example 3

A Nd—Fe—N-based magnetic powder (average particle size: about 8 μm) according to Comparative Example 3 was obtained by subjecting the oxidized Nd—Fe—N-based magnetic powder of Comparative Example 2 to the same treatment as in Example 1, except that the heat treatment atmosphere was changed from the argon atmosphere to an ammonium atmosphere, and the heat treatment time was changed from four hours to 15 minutes.

### Comparative Example 4

An amount of 300 of the Nd—Fe—N-based magnetic powder having a phosphorus compound coating portion of Comparative Example 1 was gradually heated from room temperature in an argon gas atmosphere to perform heat treatment at 420° C. for four hours, thereby obtaining a Nd—Fe—N-based magnetic powder (average particle size: about 8 μm) according to Comparative Example 4.

Table 1 shows the heat treatment conditions for the magnetic powders of Examples 1 to 3 and Comparative Examples 1 to 4.

TABLE 1

| | Oxidation step | | | Annealing step | | | |
|---|---|---|---|---|---|---|---|
| | | Tem- | | | Tem- | | |
| | Atmo- | pera- | | Atmo- | pera- | | |
| | sphere | ture | Time | sphere | ture | Time | |
| Example 1 | Air | 465° C. | 4 hr | Ar | 420° C. | 4 | hr |
| Example 2 | Air | 465° C. | 4 hr | N₂ | 420° C. | 30 | min |
| Example 3 | Air | 465° C. | 4 hr | H₂ | 420° C. | 15 | min |
| Comparative | — | — | — | — | — | — | |
| Example 1 | | | | | | | |
| Comparative | Air | 465° C. | 4 hr | — | — | — | |
| Example 2 | | | | | | | |
| Comparative | Air | 465° C. | 4 hr | NH₃ | 420° C. | 15 | min |
| Example 3 | | | | | | | |
| Comparative | — | — | — | Ar | 420° C. | 4 | hr |

Example 4

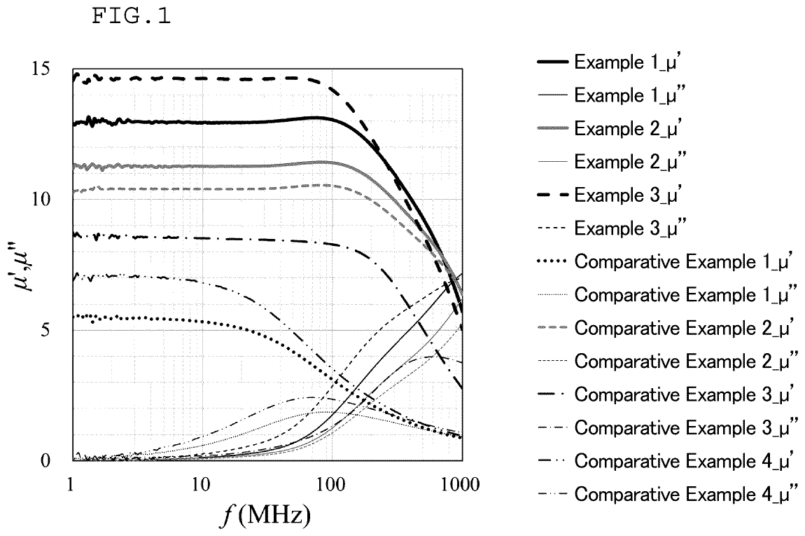

The frequency dependencies of the complex relative permeability of the magnetic powders of Examples 1 to 3 and Comparative Examples 1 to 4 over 1 MHz to 1 GHz were measured by the above-described method. FIG. 1 shows the results. Moreover, Table 2 shows the frequency characteristics at 2 MHz, 10 MHz, 50 MHz, and 100 MHz.

TABLE 2

| | μ′ at | μ″ at | tan δ at | μ′ at | μ″ at | tan δ at | μ′ at | μ″ at | tan δ at | μ′ at | μ″ at | tan δ at |
|---|---|---|---|---|---|---|---|---|---|---|---|---|
| | 2 MHz | 2 MHz | 2 MHz | 10 MHz | 10 MHz | 10 MHz | 50 MHz | 50 MHz | 50 MHz | 100 MHz | 100 MHz | 100 MHz |
| Example 1 | 12.85 | 0.00 | 0.00 | 12.94 | 0.13 | 0.01 | 13.06 | 0.68 | 0.05 | 13.05 | 1.76 | 0.13 |
| Example 2 | 11.26 | 0.03 | 0.00 | 11.27 | 0.11 | 0.01 | 11.36 | 0.48 | 0.04 | 11.41 | 1.25 | 0.11 |
| Example 3 | 14.60 | 0.02 | 0.00 | 14.63 | 0.27 | 0.02 | 14.65 | 1.29 | 0.09 | 14.20 | 2.84 | 0..20 |
| Comparative | 5.46 | 0.18 | 0.03 | 5.33 | 0.60 | 0.11 | 4.18 | 1.70 | 0.41 | 3.11 | 1.87 | 0.60 |
| Example 1 | | | | | | | | | | | | |
| Comparative | 10.40 | 0.01 | 0.00 | 10.39 | 0.08 | 0.01 | 10.48 | 0.40 | 0.04 | 10.52 | 1.07 | 0.10 |
| Example 2 | | | | | | | | | | | | |
| Comparative | 8.65 | 0.10 | 0.01 | 8.53 | 0.18 | 0.02 | 8.42 | 0.69 | 0.08 | 8.29 | 1.32 | 0.16 |
| Example 3 | | | | | | | | | | | | |
| Comparative | 7.07 | 0.18 | 0.03 | 6.79 | 0.94 | 0.14 | 4.92 | 2.35 | 0.48 | 3.53 | 2.36 | 0.67 |
| Example 4 | | | | | | | | | | | | |

In Table 2, Examples 1 to 3 had a higher μ′ and a lower μ″ at 2 MHz than Comparative Examples 1 to 4. This is probably because the weakly magnetic α-Fe₂O₃ formed on the particle surface was converted to magnetite (Fe₃O₄) or maghemite (γ-Fe₂O₃) by heat treatment in an Ar atmosphere (Example 1), or to α-Fe or Fe₃O₄ by heat treatment in a H₂ atmosphere (Example 3).

In FIG. 1, the α-Fe-containing rare earth-iron-based magnetic materials of all examples had a μ′ at 12 MHz of at least 11 and a very good tan δ at 10 MHz of not higher than 0.02, and thus they were found to have high permeability and high efficiency.

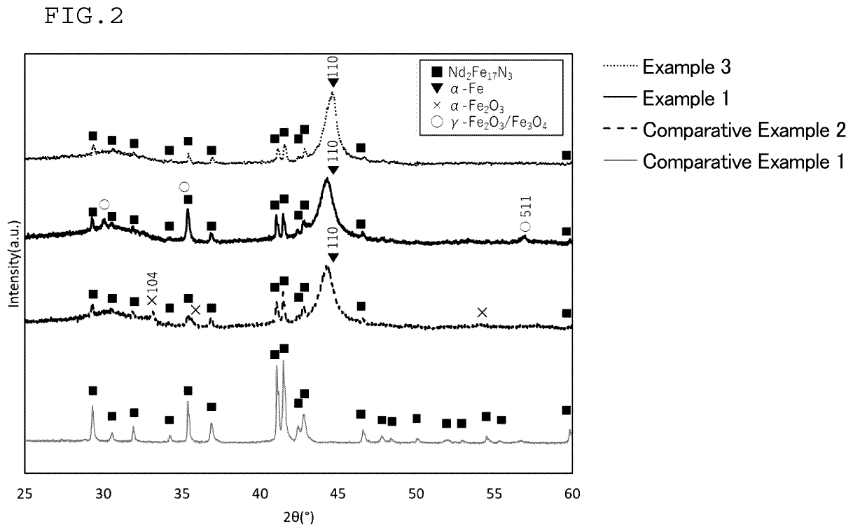

FIG. 2 shows the XRD patterns of the magnetic powders of Examples 1 and 3 and Comparative Examples 1 and 2 measured under the above-described conditions. The peaks around 2θ=33° and around 2θ=49.7° of hematite (α-Fe₂O₃) formed by the oxidation treatment in Comparative Example 2 disappeared in the pattern of Example 1. Further, new peaks around 2θ=30° and around 2θ=560 appeared in the pattern of Example 1. These peaks are considered to correspond to magnetite or maghemite. Moreover, the magnetic powders of all examples and Comparative Examples 2 and 3 showed broad peaks around 2θ=44° to 45°. Thus, the presence of an α-Fe-containing region containing nanocrystals was confirmed.

Peaks were found on the lower angle side than the common peaks indicating α-Fe. This shift to the lower angle side is probably due to the lattice of α-Fe itself being distorted to lattice-match with a rare earth oxide, nitride, or oxynitride.

The ratios (I)/(II) of the diffraction peak intensity (I) of the (110) plane of α-Fe to the peak intensity (II) of the strongest line of a rare earth-iron-nitrogen-based compound in the XRD diffraction patterns of Examples 1 and 3 were 2.9 and 4.4, respectively, which are within the range of at least 0.01 but lower than 100.

Moreover, in the XRD diffraction pattern of Example 1, the ratio (I)/(II) of the diffraction peak intensity (I) of the (511) plane of magnetite or maghemite to the peak intensity (II) of the strongest line of the rare earth-iron-nitrogen-based compound was 0.3, which is within the range of at least 0.01 but lower than 100.

Further, in the XRD diffraction pattern of Example 1, the ratio (I)/(II) of the diffraction peak intensity (I) of the (104) plane of hematite to the diffraction peak intensity (II) of the (511) plane of magnetite or maghemite was 0, which is within the range of at least 0 but lower than 10.

Although no diffraction line of magnetite or maghemite was found in the XRD diffraction pattern of Example 3, its presence was confirmed by STEM-EDS.

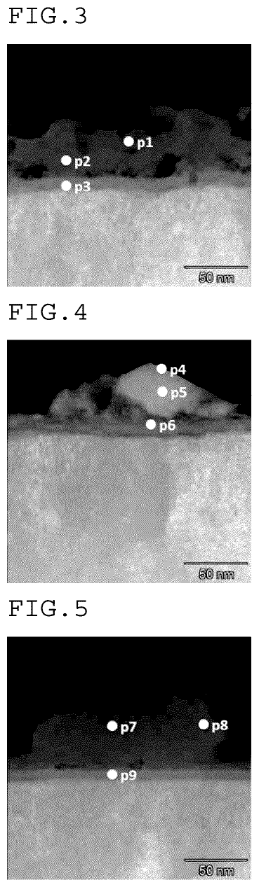

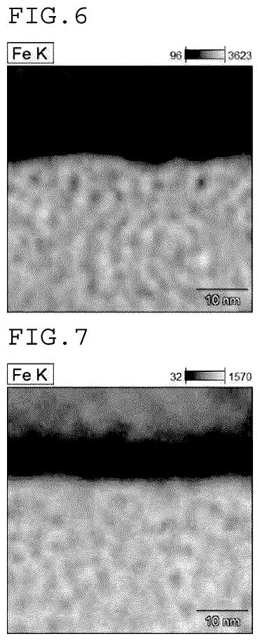

The near-surface portions of the magnetic powders of Comparative Examples 1 and 2 and Examples 1 and 3 were observed with an STEM (JEOL Ltd., model No. JEM-F200, acceleration voltage: 200 kV) and an EDS (system: JEOL Ltd., model No. SD100HR, detector: dry SD detector, JEOL Ltd.) attached to the STEM. The STEM and STEM-EDS results were observed at one million magnification for FIGS. 3, 4, and 5, and at four million magnification for FIGS. 6 and 7.

FIG. 3 shows an STEM-DF image of Comparative Example 2. Table 3 shows the results (at %) quantified by EDS at p1, p2, and p3 in FIG. 3.

TABLE 3

| | O | P | Fe | Nd |
|---|---|---|---|---|
| p1 | 60.9 | | 39.1 | |
| p2 | 59.4 | 6.8 | 27.1 | 6.1 |
| p3 | 58.4 | 15.6 | 5.6 | 19.7 |

FIG. 4 shows an STEM-DF image of Example 1. Table 4 shows the results (at %) quantified by EDS at p4, p5, and p6 in FIG. 4.

TABLE 4

| | O | P | Fe | Nd |
|---|---|---|---|---|
| p4 | 60.5 | | 39.5 | |
| p5 | 59.3 | 4.7 | 31.7 | 4.3 |
| p6 | 61.3 | 14.9 | 4.5 | 19.3 |

FIG. 5 shows an STEM-DF image of Example 3. Table 5 shows the results (at %) quantified by EDS at p7, p8, and p9 in FIG. 5.

TABLE 5

| | O | P | Fe | Nd |
|---|---|---|---|---|
| p7 | 56.7 | | 43.3 | |
| p8 | 8.6 | | 91.4 | |
| p9 | 60.9 | 15.4 | 6.3 | 17.4 |

The STEM and EDS results were observed at one million magnification (FIG. 3), at one million magnification (FIG. 4), and at one million magnification (FIG. 5).

With regard to Comparative Example 2, the results in Table 3 and FIG. 3 show that the composition at p1 is almost consistent with Fe₂O₃, which, when combined with the XRD measurement results, suggests that the composition at p1 is largely hematite. A phosphorus compound coating portion containing Nd, Fe, P, and O is considered to be present at p3. The point p2 showed an intermediate composition between those of p1 and p3, suggesting that the presence of a mixture of the above compounds.

With regard to Example 1, the results in Table 4 and FIG. 4 show that the composition at p4 is almost consistent with Fe₂O₃, which, when combined with the XRD measurement results, suggests that the composition at p4 is largely magnetite or maghemite. A microcrystalline phosphorus compound coating portion based on a solid solution of neodymium phosphate and iron phosphate and containing Nd, Fe, P, and O is considered to be present at p6. The point p5 showed an intermediate composition between those of p4 and p6, suggesting the presence of a mixture of the above compounds.

With regard to Example 3, the results in Table 5 and FIG. 5 show that the composition at p8 is largely Fe, suggesting that the composition at p8 mainly contains α-Fe produced by reduction of the hematite observed at p1 in Comparative Example 2 with hydrogen. The oxygen content at p7 is higher than that at p8, suggesting that only the outermost surface was re-oxidized, and a mixture of hematite, magnetite, and maghemite was present at p7.

FIG. 6 shows an STEM-EDS image observed for Fe in Comparative Example 2. In FIG. 6, three regions were found based on the variations in shades. Correspondence with FIG. 3 indicates that these regions were, in order from top to bottom, an iron oxide-containing region containing hematite, a phosphorus compound coating portion, and an α-Fe-containing region. The results were also consistent for Fe content.

FIG. 7 shows an STEM-EDS image observed for Fe in Example 1. As in FIG. 6, the presence of an α-Fe-containing region was confirmed beneath a phosphorus compound coating portion.

The layer thicknesses of the iron oxide-containing region, the phosphorus compound coating portion, and the α-Fe-containing region in Comparative Example 2 were 70 nm, 10 nm, and 470 nm, respectively.

The layer thicknesses of the iron oxide-containing region, the phosphorus compound coating portion, and the α-Fe-containing region in Example 1 were 90 nm, 10 nm, and 870 nm, respectively.

The layer thicknesses of the iron oxide-containing region, the phosphorus compound coating portion, and the α-Fe-containing region in Comparative Example 3 were 45 nm, 11 nm, and 240 nm, respectively. The α-Fe region in the iron oxide-containing region had a layer thickness of 42 nm.

### Example 4

The phosphorus compound-coated Nd₂Fe₁₇N₃ soft magnetic powder prepared in Example 1 and an epoxy resin (thermosetting resin) were mixed and then kneaded to prepare a compound. The amount of the phosphorus compound-coated Nd₂Fe₁₇N₃ soft magnetic powder in the compound was 96% by mass. The compound was charged into a mold, molded at an increased pressure of 1.4 GPa, and then heat-cured in vacuum at 150° C. for two hours to prepare a toroidal molded product with an inner diameter of 3.1 mm, an outer diameter of 8 mm, and a thickness of 1.30 mm.

### Example 5

The phosphorus compound-coated Nd₂Fe₁₇N₃ soft magnetic powder prepared in Example 1, magnetite (Fe₃O₄, average particle size: 0.1 μm), and an epoxy resin (thermosetting resin) were mixed and then kneaded to prepare a compound. The amount of the phosphorus compound-coated Nd₂Fe₁₇N₃ soft magnetic powder in the compound was 93.5% by mass, and the amount of magnetite in the compound was 2.5% by mass. The compound was charged into a mold, molded at an increased pressure of 1.4 GPa, and then heat-cured in vacuum at 150° C. for two hours to prepare a toroidal molded product with an inner diameter of 3.1 mm, an outer diameter of 8 mm, and a thickness of 1.28 mm.

Using an impedance analyzer (E4991B, Keysight), the complex relative permeability of the molded products of Examples 4 and 5 in a frequency range of 1 MHz to 1 GHz was evaluated from the inductance determined using a single-turn inductor-type test fixture. In addition, the values of μ′ and μ″ obtained were used to calculate tan δ=μ″/μ′ The frequency characteristics at 10 MHz, 50 MHz, and 100 MHz are shown in Table 6.

TABLE 6

| | μ′ at | tan δ at | μ′ at | tan δ at | μ′ at | tan δ at |
|---|---|---|---|---|---|---|
| | 10 MHz | 10 MHz | 50 MHz | 50 MHz | 100 MHz | 100 MHz |
| Example 4 | 10.31 | 0.00 | 10.44 | 0.03 | 10.48 | 0.10 |
| Example 5 | 10.65 | 0.00 | 10.74 | 0.03 | 10.86 | 0.09 |

A comparison between Examples 4 and 5 shows that the addition of a magnetic metal oxide (Fe₃O₄:magnetite) to the phosphorus compound-coated Nd₂Fe₁₇N₃ soft magnetic powder results in a higher μ′ in a frequency range of 10 MHz to 100 MHz, as well as an at least comparable tan δ, thereby achieving higher efficiency.

What is claimed is:

1. An α-Fe-containing rare earth-iron-based magnetic powder, comprising:
a core region containing a rare earth R and Fe, where R represents at least one selected from the group consisting of Y, La, Ce, Pr, Nd, Pm, Eu, Gd, Tb, Dy, Ho, Er, Tm, Yb, Lu, and Sm;
an α-Fe-containing region located outside the core region and containing α-Fe and at least one selected from the group consisting of oxides, nitrides, and oxynitrides of the rare earth R; and
an iron oxide-containing region located outside the α-Fe-containing region and containing magnetite or maghemite.

2. The α-Fe-containing rare earth-iron-based magnetic powder according to claim 1,
wherein, when the rare earth R includes Sm, Sm constitutes less than 50 at % of a total R content.

3. The α-Fe-containing rare earth-iron-based magnetic powder according to claim 1,
wherein the core region further contains N.

4. The α-Fe-containing rare earth-iron-based magnetic powder according to claim 1,
wherein the α-Fe-containing region contains:
a nanocrystal comprising the at least one selected from the group consisting of oxides, nitrides, and oxynitrides of the rare earth R; and
a nanocrystal comprising α-Fe.

5. The α-Fe-containing rare earth-iron-based magnetic powder according to claim 1,
wherein the α-Fe-containing rare earth-iron-based magnetic powder further comprises a phosphorus compound coating portion between the α-Fe-containing region and the iron oxide-containing region.

6. The α-Fe-containing rare earth-iron-based magnetic powder according to claim 1,
wherein the α-Fe-containing region has a thickness that is at least 0.01% but less than 50% of an average particle size of the α-Fe-containing rare earth-iron-based magnetic powder.

7. The α-Fe-containing rare earth-iron-based magnetic powder according to claim 1,
wherein the α-Fe-containing region has a thickness that is at least 1 nm but not more than 80 μm.

8. The α-Fe-containing rare earth-iron-based magnetic powder according to claim 1,
wherein the core region contains a rare earth-iron-nitrogen-based compound, and
the α-Fe-containing rare earth-iron-based magnetic powder has an XRD diffraction pattern in which a ratio (I)/(II) of a diffraction peak intensity (I) of a (110) plane of α-Fe to a peak intensity (II) of a strongest line of the rare earth-iron-nitrogen-based compound is at least 0.01 but lower than 100.

9. The α-Fe-containing rare earth-iron-based magnetic powder according to claim 1,
wherein the core region contains a rare earth-iron-nitrogen-based compound, and
the α-Fe-containing rare earth-iron-based magnetic powder has an XRD diffraction pattern in which a ratio (I)/(II) of a diffraction peak intensity (I) of a (511) plane of magnetite or maghemite to a peak intensity (II) of a strongest line of the rare earth-iron-nitrogen-based compound is at least 0.01 but lower than 100.

10. The α-Fe-containing rare earth-iron-based magnetic powder according to claim 1,
wherein the core region contains a rare earth-iron-nitrogen-based compound, and
the α-Fe-containing rare earth-iron-based magnetic powder has an XRD diffraction pattern in which a ratio (I)/(II) of a diffraction peak intensity (I) of a (104) plane of hematite to a diffraction peak intensity (II) of a (511) plane of magnetite or maghemite is at least 0 but lower than 10.

11. The α-Fe-containing rare earth-iron-based magnetic powder according to claim 1,
wherein the α-Fe-containing rare earth-iron-based magnetic powder has a tan δ at 10 MHz that is not more than 0.1 and a μ′ at 10 MHz that is at least 11.

12. The α-Fe-containing rare earth-iron-based magnetic powder according to claim 1,
wherein the α-Fe-containing rare earth-iron-based magnetic powder has a tan δ at 50 MHz that is not more than 0.2 and a μ′ at 50 MHz that is at least 11.

13. The α-Fe-containing rare earth-iron-based magnetic powder according to claim 1,
wherein the α-Fe-containing rare earth-iron-based magnetic powder has a tan δ at 100 MHz that is not more than 0.3 and a μ′ at 100 MHz that is at least 11.

14. A magnetic material for magnetic field amplification, comprising the α-Fe-containing rare earth-iron-based magnetic powder according to claim 1.

15. The magnetic material for magnetic field amplification according to claim 14, further comprising a resin.

16. The magnetic material for magnetic field amplification according to claim 14 for use in wireless power transfer.

17. The magnetic material for magnetic field amplification according to claim 14 for use in transformers, inductors, or reactors of circuits for high frequencies higher than 20 MHz.

18. A magnetic material for hyper-high frequency absorption, comprising the α-Fe-containing rare earth-iron-based magnetic powder according to claim 1.

19. A method of producing an α-Fe-containing rare earth-iron-based magnetic powder, the method comprising:
performing a phosphorus treatment comprising adding an inorganic acid to a slurry containing: a rare earth-iron-based magnetic powder containing a rare earth R and Fe, where R represents at least one selected from the group consisting of Y, La, Ce, Pr, Nd, Pm, Eu, Gd, Tb, Dy, Ho, Er, Tm, Yb, Lu, and Sm; water; and a phosphorus-containing substance, to form a phosphorus compound coating portion on the rare earth-iron-based magnetic powder, thereby obtaining a rare earth-iron-based magnetic powder having the phosphorus compound coating portion;
performing an oxidation comprising heat-treating the rare earth-iron-based magnetic powder having the phosphorus compound coating portion at a temperature that is at least 350° C. but not higher than 600° C. in an oxygen-containing atmosphere to obtain an oxidized rare earth-iron-based magnetic powder having the phosphorus compound coating portion; and
performing an annealing comprising heat-treating the oxidized rare earth-iron-based magnetic powder having the phosphorus compound coating portion at a temperature that is at least 200° C. but not higher than 600° C. in an atmosphere comprising an inert gas or a nitrogen atom-free reducing gas.

20. The method of producing an α-Fe-containing rare earth-iron-based magnetic powder according to claim 19,
wherein the inert gas is Ar gas or N₂ gas.

21. The method of producing an α-Fe-containing rare earth-iron-based magnetic powder according to claim 19,
wherein the nitrogen atom-free reducing gas is H₂ gas.

22. The method of producing an α-Fe-containing rare earth-iron-based magnetic powder according to claim 19,
wherein, in the phosphorus treatment, the inorganic acid is added to adjust a pH of the slurry to at least 1 but not higher than 4.5.

23. The method of producing an α-Fe-containing rare earth-iron-based magnetic powder according to claim 19, further comprising, after the annealing, heat-treating the α-Fe-containing rare earth-iron-based magnetic powder at a temperature that is at least 200° C. but not higher than 600° C. in an oxygen-containing atmosphere.

24. The magnetic material for magnetic field amplification according to claim 15, further comprising at least one selected from the group consisting of a magnetic metal and a magnetic metal oxide.

25. The magnetic material for magnetic field amplification according to claim 24,
wherein the magnetic metal oxide is magnetite.
